(19) United States
(12) Patent Application Publication
(10) Pub. No.: US 2008/0162275 A1
(43) Pub. Date: Jul. 3, 2008

(54) Author-assisted information extraction

(76) Inventors: James D. Logan, Candia, NH (US); Bentley Clinton, Boston, MA (US)

Correspondence Address: Charles G. Call, 215 WEST HURON ST., UNIT 2, CHICAGO, IL, 60610-3331, US

(21) Appl. No.: 11/894,256

(22) Filed: Aug. 20, 2007

Related U.S. Application Data
(60) Provisional application No. 60/839,405, filed on Aug. 21, 2006.

(51) Int. Cl. G07C 13/00

(52) U.S. Cl. 705/12

(57) ABSTRACT

A system for extracting information from web pages wherein the web page author assists the user to easily collect specific facts and key points from the page. The system includes a first sub-system for presenting the facts and key points to the user at appropriate times and to allow the facts and key points to be saved, and a second sub-system for facilitating the creation of such facts and key points.

### CROSS-REFERENCE TO RELATED APPLICATION

This application claims the benefit of U.S. Provisional Application No. 60/839,405, filed on Aug. 21, 2006, the disclosure of which are incorporated herein by reference.

### COPYRIGHT STATEMENT;

A portion of the disclosure of this patent document including the program listing appendix contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO COMPUTER PROGRAM LISTING APPENDIX

A computer program listing appendix is stored on each of two duplicate compact disks which accompany this specification. The listings are recorded as ASCII text in IBM PC/MS DOS compatible files which have the creation dates, sizes (in kilobytes) and filenames listed below:

| Date Created | Size (KB) | Filename |
|---|---|---|
| Aug. 19, 2007 | 1,002 | 2006_code.txt |
| Aug. 19, 2007 | 250 | 2007_code_(A).txt |
| Aug. 19, 2007 | 677 | 2007_code_(B).txt |

### FIELD OF THE INVENTION

This invention comprises an on-line software application offering users unique ways to extract and save information from web pages; format, organize and use such information; automatically re-present such information to users in order to enhance retention and familiarity; and scan web pages being read to look for recurrences of the information or similar information.

### BACKGROUND

Many users of the Internet are consuming vast amounts of written material while browsing the web. The advent of RSS technology has made more reading material than ever easily accessible to users. With RSS, this material is ever more customized and filtered to appeal to a given reader's interests and tastes thus stimulating even more consumption.

Technology has also rapidly developed to let readers save and share material discovered on the Internet. Social bookmarking is one such technology. Sites offering this technology, such as del.icio.us, allow a user to bookmark a multitude of specific pages, be they from a traditional website or a blog. Lists of such bookmarked pages can then be shared with others who have similar interests. The bookmarking sites store the metadata users contribute about specific pages while the pages themselves remain un-copied at their original location.

Supporting social bookmarking are the related activities of rating and tagging content. The former allows users to rate the quality of pages of interest while the latter allows users to assign descriptive words to these pages, which can be used later as a means to sort and search for relevant data.

Sites offering the ability to save information of finer granularity than entire pages include ClipMarks, as described at http://www.clipmarks.com/ (the information posted on this site is incorporated herein by reference in its entirety), and a downloaded program called Net Snippets. These applications allow users to extract portions of a webpage and in the case of ClipMarks, save, share, tag and rate the extracts. With Net Snippets, aggregations of partial or whole pages can be assembled and privately stored, or they may be shared in a public fashion.

While these sites allow users to create notes about a specific URL, and to make such annotations public, and Diigo, as described at http://www.diigo.com/ (the information posted on this site is incorporated herein by reference in its entirety), allows users to highlight text on a blog page, none allows such notes to be juxtaposed with the original page and viewed at the same URL as the original parent page. In the case of Diigo, a cached copy of the highlighted page is saved on the Diigo server—it is not dynamically served up by the blogging platform. In the case of other bookmarking applications allowing for the creation of notes, users must visit those sites to find such notes.

Finally, a class of information-saving sites has arisen (of which Google Notebook, described at http://www.google.com/notebook/ (the information posted on this site is incorporated herein by reference in its entirety), is an example) that are focused more on the manual entry of notes rather than simply bookmarking URLs. These programs encourage the input of manually entered information as notes, in addition to allowing users to save partial (or even complete) web pages as notes.

Various storage models are used by these “save-what-I've-read” applications. Sometimes the saved material is merely referenced by the bookmark. Other times, the material is copied and saved to a new server. Some programs even facilitate the storage of the material of interest on the user?s PC.

In all current notetaking or bookmarking systems, users preserve information for future reference (i.e., with the intent of later revisiting the saved information in order to further explore, absorb, or retain it). In many cases, however, users accumulate many bookmarks but rarely remember to revisit the pages per their original intent. Thus, information originally intended to be absorbed may be forgotten due to lack of repeated exposure.

All the aforementioned and related applications, however, offer less than ideal abilities regarding the following functions:
1. Ease of Extraction: A means by which extracting key points from a page can be done with as few keystrokes and mouse actions as possible, particularly in a way such that the author of the page or other readers could facilitate the process.
2. Ease of Organization: A means to format the saved information into a more formal structure such that traditional database concepts can be used to organize, use, and share the data.
3. Automatic Re-use: A means for automatically retrieving specific saved data and re-presenting it to the user in order to increase the ability of the user to memorize, learn, or become familiar with such information.
4. Automatic Spotting of Recurrences: A means for pointing out to readers when material identical or similar to what has been noted and saved previously reoccurs on a web page being read.

When reading a webpage, each user finds some parts more interesting than others, some parts more useful than others, and some areas more worth saving than others. Sorting out the interesting and useful material from the uninteresting and not-useful can be difficult. If the user saves a webpage for review (for instance, via a bookmarking website) and returns later to re-read such page, the effort of sorting-out of the good from the bad often needs to be largely re-done, wasting much of the effort expended in the first instance.

Whereas, tools exist to help users extract snippets and facts from a web page, such activity is entirely controlled by the user who must highlight or extract the parts of the page they wish to save. No assistance or support for this activity is given by the author or supplier of the webpage being disassembled and saved.

On the other hand, several websites do offer users the ability to easily save specific pages from their site by clicking on a link. Such pages can be classified, tagged and rated. Websites offering such a service include the New York Times, as described at http://www.nytimes.com/ (the information posted on this site is incorporated herein by reference in its entirety), and MarketWatch, as described at http://www.marketwatch.com/ (the information posted on this site is incorporated herein by reference in its entirety). These services do not offer the user the ability to save just the portions of the page that they may be interested in, however. In all cases, the whole page is saved as a unit.

There are also several on-line database programs, such as Zoho Creator, as described at http://www.zoho.com/ (the information posted on this site is incorporated herein by reference in its entirety), whereby users can collaboratively build a database and share, or keep private, items within the database. Such applications have features and attributes similar to PC-based database programs. Furthermore, social bookmarking sites, photo-sharing sites such as Flickr, as described at http://www.flickr.com/ (the information posted on this site is incorporated herein by reference in its entirety), and even on-line spreadsheet programs can all act as on-line databases of various sorts.

An important and popular technology to filter and focus information read by Internet users is RSS. This technology is often used by publishers and authors who produce a flow of content to be read off site on the RSS reader, or to be used to guide readers back to the originating news sites and blogs.

Using RSS, authors can provide a machine-readable summary of their web pages that is usually accessible as an adjunct to the webpage itself. Each XML element of an RSS feed includes a Title, an optional Description, a Publication Date, and a Link field, among other items. The title is often the article title or a short description that is usually composed so as to entice readers to click on the link and read the whole article. (An RSS specification is located here: http://blogs.law.harvard.edu/tech/rss).

Users, for their part, employ RSS readers which can monitor any number of RSS “feeds”, each of which can originate from a different website. The reader presents article titles and sometimes descriptions from the designated feeds on a “presentation page”. Titles can have a maximum length of 160 characters, while descriptions can be of any length. Users may click on a given title and be taken to the full version of the article.

An RSS reader will poll sites of interest on a periodic basis looking for newly published items. Sometimes the reader filters the XML metadata for keywords to decide if the posting, article, or web page should be presented to the user. The reader may limit the maximum number of articles that can be displayed at once. Some readers will delete or shade items once the user has clicked on them. Some readers allow items to be saved in designated folders.

RSS reader displays are frequently visited. In addition, RSS reading capabilities are also increasingly being built into web homepages. As such, these RSS-based lists are viewed often and a feed presented via an RSS reader will therefore have a high probability of being viewed by the reader who programs the feed.

Another recently popular means of bringing information to the attention of users is via widgets or gadgets. These are constructs that users can place on their homepage that will import and format data from a different website. Such data could be baseball scores, weather reports, or stock prices. Often the user will configure the widget to show just the information of interest and in that way personalize the widget's presentation. Often widgets pull information from an RSS feed and in that sense are small RSS readers. By assembling numerous such widgets on a homepage, such a homepage can take on the characteristics of an RSS reader.

Another type of commonly used Internet application is on-line bookmarking. Typically, people will bookmark pages or URLs, often representing websites' homepages, special pages on retail sites, new articles, or blog posts. The bookmark typically consists of a page title, a description, tags, and the URL of the page. The title and description can sometimes be automatically filled in by the application, although the user could over-ride these and input their own. The URL is automatically detected when the bookmarking is done via a browser tool and the user is at the page being bookmarked.

The reasons for bookmarking a page are numerous and include a desire to review the information later for further thought or analysis, or to learn and absorb the information at some point, or just to have it accessible in case it is ever needed. Often however, people tend to accumulate large collections of interesting bookmarks but then never review the information contained on the saved pages, or never even look at the bookmarks themselves again. Thus while these bookmarks serve a contingent purpose in saving information in case it is needed later, the bookmarking process does not directly help in learning information or even exposing it to view again.

Web browsers and other Internet technologies offer various means to link readers of a web page to additional relevant material. The latest focus is on automatic means to find related information on either the whole document or page, or to find related information on selected sub-sets of the page or document under consideration.

Current offerings include the Wall Street Journal, described at http://online.wsj.com/public/us (the information posted on this site is incorporated herein by reference in its entirety), which offers links (via a right click menu) related to whatever material a user highlights on a page in the expectation that some of the presented material may be of interest. Another example of offering additional information is the Pop-Up Politician, described at http://sunlightlabs.com/popuppoliticians/ (the information posted on this site is incorporated herein by reference in its entirety), an Ajax widget from the Sunlight Foundation that lets anyone link a US Congress person's name on his/her blog to a popup window about that politician. Another example is “Sphere It” technology, described at http://www.sphere.com/ (the information posted on this site is incorporated herein by reference in its entirety), which uses a widget to show readers other blog posts or articles that relate to the post or article they are reading. It does this by performing a semantic analysis on the text within the page being searched. The user does not input anything or select text to get the result—it is based on the entirety of the post being “Sphered”. A similar application that was released in early 2007 is BlogRovr, described at http://blogrovr.com/, (the information posted on this site is incorporated herein by reference in its entirety). A user of BlogRovr inputs a list of feeds at the main BlogRovr site. When a user visits any website, the BlogRovr tray will pop out containing any posts from the user's specified feeds that are about the site that the user is currently visiting.

Although the information presented from these applications is supposed to be relevant to the information selected by the user (either at the page, post or highlight level), it is not personalized in any manner. In particular, the services have no information regarding whether the additional information being offered will be of particular interest to that particular reader (except to the extent that in the case of BlogRovr where the user specified what sources to pull the information from).

Services that find additional information that are more personalized revolve around alerts, such as the application known as Google's Alerts, described at http://www.google.com/alerts (the information posted on this site is incorporated herein by reference in its entirety). Users of this system input a list of search terms and when Google combs the web, any page with that term in it, will be flagged and the user notified. Naturally, this will lead to a large number of “hits” if the term is too general. Another similar technique is built into some RSS readers. They enable readers to input search terms and if the terms appear in an article within any monitored feeds, such an article or post would be flagged for the user. Finally, a system offered at this website Eagle eye Searcher 1.0, described at http://www.freedownloadscenter.com/Network_and_Internet/Web_Searching_Tools/Eagl e_eye_Searcher.html, (the information posted on this site is incorporated herein by reference in its entirety) will allow users to input a list of items to search for and highlight such material as it appears on any webpage.

These alert systems are similar to the ability of some RSS readers, such as My Yahoo, described at http://my.yahoo.com/ (the information posted on this site is incorporated herein by reference in its entirety), or Newsgator, described at http://www.newsgator.com/ (the information posted on this site is incorporated herein by reference in its entirety), to fabricate feeds from keywords. A user puts in a keyword, for instance Hillary Clinton. The RSS reader combs the Internet for any postings from any feeds about Hillary Clinton and puts these posts into a feed for the user to consume. The Real Time Matrix/iJ.am site, described at http://www.realtimematrix.com/index.php (the information posted on this site is incorporated herein by reference in its entirety), has a similar set up. Here, users create “Channels” based on keywords. A user can specify what types of posts they will get by specifying words to include in the search and also words to exclude.

### SUMMARY

What is needed to allow users maximum benefit from reading a webpage and sorting out useful from non-useful information is a means to extract portions of interest. Ideally, such means would be supported by the author or the website itself. The “TakeAwaz” technology described below allows the author to assist readers of a webpage in saving desired segments, thus minimizing the effort required by each reader to do this on their own.

TakeAwaz is a technology for extracting information from a webpage where the author optionally is able to assist the reader in doing so. It would focus on allowing users to easily view and subsequently save specific facts and key points—“takeaways”—from a given web page, blog post, or news article. Such technology would consist of one sub-system that would present such takeaways to web readers at the appropriate time and allow them to be saved, and a second sub-system that would facilitate the creation of such takeaways.

The invention envisions that a takeaway would be a “parallel version” of a point, argument, or set of facts that a reader would have seen on the “parent” web page—the one being read. Such a parallel version would ideally be expressed in a more concise way than was done in the parent web page where all the nuances and details were necessarily expressed in order to get the point across. Such parallel versions would provide a pithy and structured rendition of the point to the reader that could be easily stored, retrieved, shared, and learned. Alternatively, a takeaway could be a subset of the material on the parent page that was highlighted, bolded, or visually designated in some other way. Both techniques could be used in combination.

### DESCRIPTION OF THE DRAWINGS

FIG. 1 is an example of how the parallel expression of takeaways might look to readers,

FIG. 2 is a portion of an exemplary web page showing a more precise geographical location for a takeaway,

FIG. 3 is a portion of an exemplary web page showing how various control features are available for viewing takeaways,

FIG. 4 is a portion of an exemplary web page showing how hovering over an icon or clicking it could cause a takeaway to be shown,

FIG. 5 is a portion of an exemplary web page showing ways that takeaways could be saved,

FIG. 6 shows an exemplary webpage ‘My Locker’, indicating the ability to navigate to the source of the fact,

FIG. 7 shows an exemplary input form for creating a TakeAway,

FIG. 8 shows an exemplary pop-up window displaying without re-rendering the page,

FIG. 9 shows an exemplary view of a Shared Stream,

FIG. 10 is a chart reflecting the various levels of control that are available,

FIG. 11 shows an exemplary Add a Stream webpage, offering the ability to Add, delete, update existing or takeaway copies of facts,

FIG. 12 shows an example of consensus representation of facts, averaging together all users' responses,

FIG. 13 shows an exemplary histogram reflecting the relative quantity of responses that each rating of the fact drew,

FIG. 14 is an exemplary webpage showing a Shared Stream emphasizing the metadata bar that indicates viewing authorities,

FIG. 15 shows an exemplary webpage of My Streams, sorted by audience,

FIG. 16 shows an exemplary interface reflecting the various versions of a fact and the options of accepting, rejecting or starting a new copy of the fact,

FIG. 17 shows an exemplary webpage reflecting options available for sorting facts within a stream,

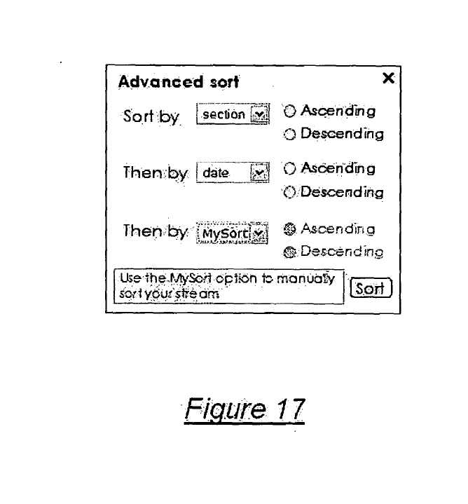

FIG. 18 shows an exemplary webpage reflecting the various options available for cycling facts,

FIG. 19 is an exemplary webpage showing RSScycle Thermometer. The thermometer meters amount if characters submitted in relation to the limit (160 characters),

FIG. 20 shows an exemplary webpage showing User highlighted information being reflected in a new browser window with references to other sites,

FIG. 21 shows an exemplary webpage showing FactFinder referencing User's databases for information specific to the highlighted term, and

FIG. 22 shows an exemplary web page whereas the User authorizes FactFinder to access their personalized databases with Username and Password.

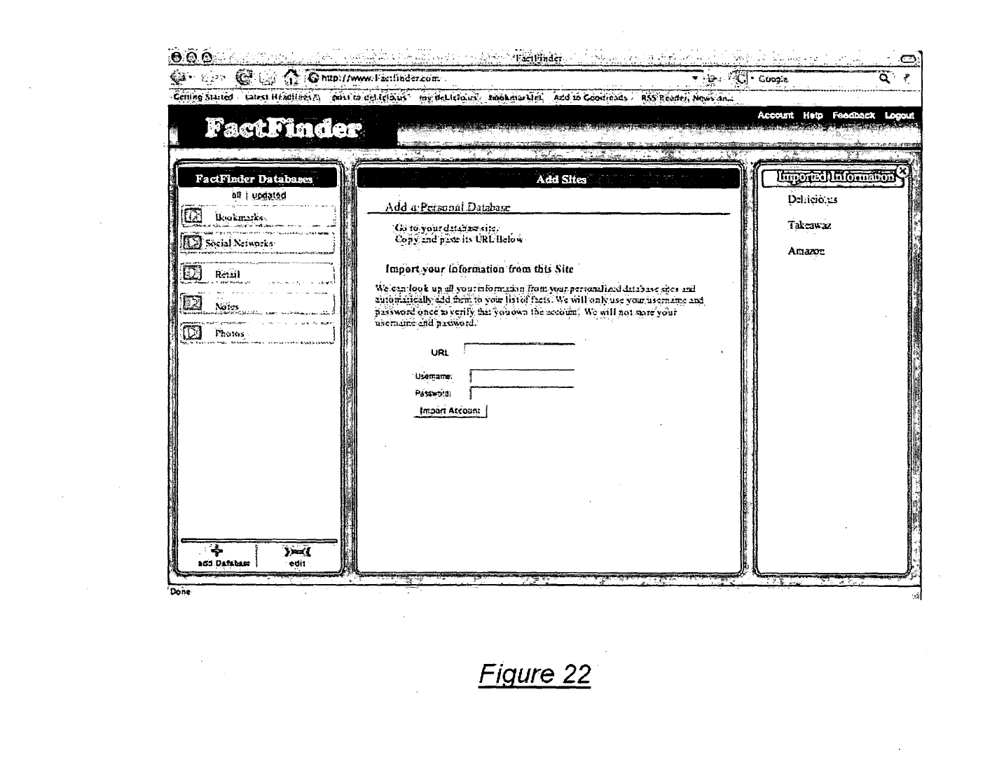

### DETAILED DESCRIPTION

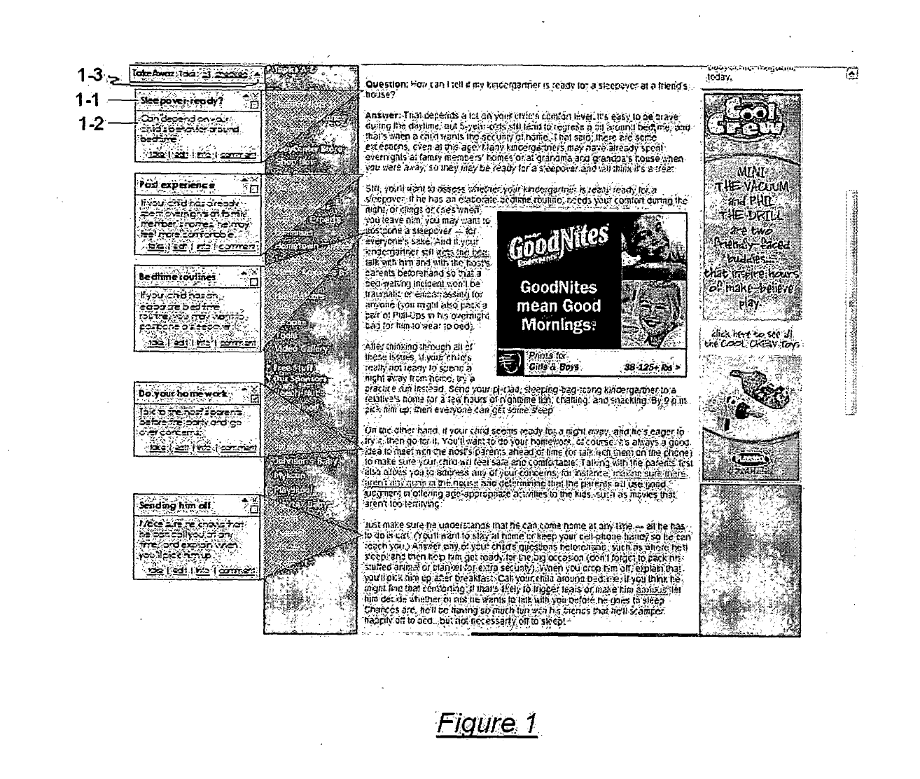

It is anticipated that each takeaway would consist of a “name” or title 1-2 and a “note” 1-2, as shown in FIG. 1, which would be a short written description of the idea or point being summarized.

An example of how the parallel expression of takeaways might look to readers is shown in FIG. 1, where the boxes represent takeaways.

The invention anticipates that each takeaway would be associated with a specific “geography” of the posting. That is, specific text in the parent page would map to the associated takeaway.

The parallel takeaways could appear or be presented in a number of ways. They could be superimposed above the parent page via a transparent overlay, or they could be presented in a sidebar, embedded within the structure of the parent page. Alternatively, the takeaway could be a sub-set of the existing text that was highlighted, bolded, italicized, or visually designated as important in some manner. While takeaways could be presented in a separate page, they would preferably be juxtaposed with the text of the parent page.

Takeaways could be optionally displayed on any parent page by the reader or author. That is, the author could opt to show the takeaways as part of the standard page presentation. Alternatively, the author could place them in the “background” and allow the reader to call them up by clicking on a TakeAwaz command, an icon, or similar construct. Such a request button could be appropriately placed on any page that had associated takeaways. In the example above, the diamond to the right of “TakeAwaz” in the upper left green box 103 of FIG. 1 is meant to display all the takeaways. Such action could be bifurcated in that the first click could display the takeaway names only, and a second click could expose the entire takeaway in all its detail.

Various ways could be used to associate each takeaway with the portion of the parent page from which some or all of the takeaway content was derived. Such an association could be represented with the triangular areas as shown in FIG. 1. Other interfaces could be offered whereby the association of geography and a takeaway was even more precise as illustrated below:

The least specific means of associating takeaways could be merely ordering the takeaways, where ever they are presented, in the same order that they appear on the webpage.

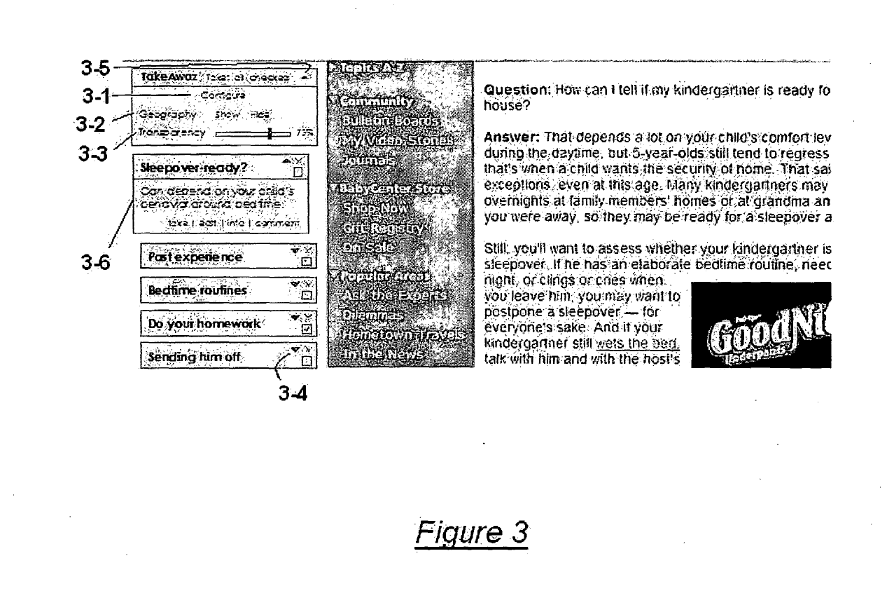

An option could exist to have the geographical links be shown or hidden. The author could set the default while users could modify the expression of such links on a page-global basis or on takeaway-by-takeaway basis. To set this feature, a “configure” link 3-1 could be available, as displayed in FIG. 3. Clicking on this link would expand the TakeAwaz box to reveal options to toggle the geographic links 3-2 and to adjust the transparency of the takeaways display 3-3.

Each takeaway could be shown in various levels of detail. The level of detail displayed could be controlled by the user, perhaps by clicking on diamond 3-4. The smallest representation would be just the name. Further expansion would display a set number of characters per takeaway. Such a short version could either be a subset of the full version (such as the first thirty characters) or a version specifically created to be shown as the abbreviated version and worded in an entirely different fashion. Finally, the entire takeaway could be presented with another click of the diamond. Such unfolding of the takeaway structure could be accomplished with a control that operated just on a designated takeaway (as diamonds 3-4), or with a control that affected the size of all the takeaways related to a specific parent page or set of parent pages as shown at 3-5.

Takeaways could be hidden from view in the same manner, either by continuing to click the detail control icon or a specific icon that would close the takeaway, or by clicking on similar controls that would control the closure of all takeaways associated with a web page or website.

Ideally, the author would offer one takeaway that mapped to the heading or headline for the webpage (such webpage generally being a blog posting, article, or similar written material). The “headline”, or main takeaway, would attempt to summarize the main point or points of the entire piece, keeping to a size that resembles that of the other takeaways 3-6.

This headline takeaway could differ from the content included in the RSS description field in that it would summarize the meta-point(s) of the post. RSS Description fields are often used to tease readers with a lead-in that will encourage them to read the whole article.

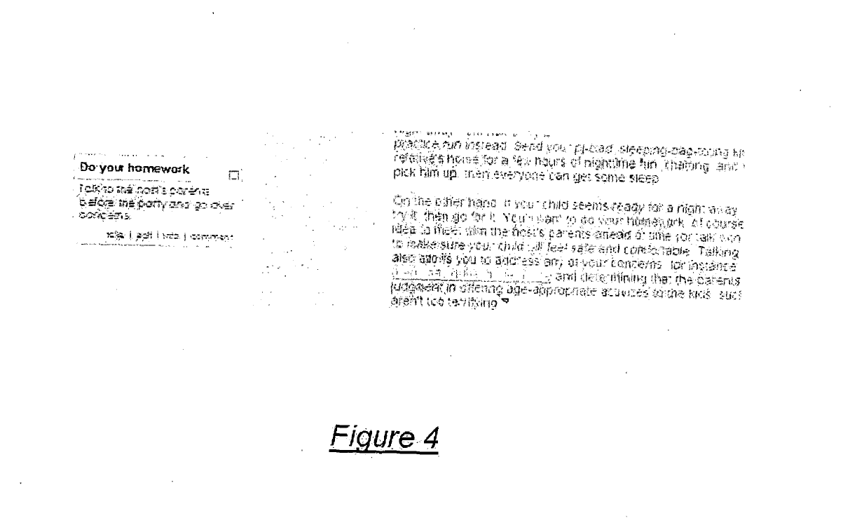

Another model of how the invention could display takeaways is illustrated in FIG. 4. In this model, the user browses over a webpage with a cursor. When the cursor moves over a geography that had an associated takeaway, it would appear in the space reserved for such takeaways or could appear in a hover that would float over the text being read but not blocking, if possible, that portion being read at the moment. Geographies containing such takeaways could be indicated by the placement of a symbol (in this example a diamond) or other notation indicating the existence of a takeaway. The application might require that the user click such symbol to display the takeaway, or the takeaway could be displayed if the cursor merely passed over the symbol or a specific region associated with such symbol.

Alternatively, the system could be set up with no takeaway symbols being displayed. The takeaways, be they bubbles, hovers, or highlighted text, could then appear when the user moved the cursor over regions of text associated with such takeaways or when the user clicked on any text in such an area.

This information display technique might seem similar to another in use on the Internet that displays additional text in an on-screen hover when the cursor moves over a specific location on the page. Such a technique is used by IntelliTXT, as described at http://www.intellitxt.com/ (the information posted on this site is incorporated herein by reference in its entirety), to display ad information when a user hovers over a designated item on a web page. The difference, however, is that in those cases, the underlying text serves as a type of “hyperlink”. When the user interacts with the IntelliTXTt link (by hovering over it) additional text related to the material under the hover is displayed. Another distinction with IntelliTXT technology is that the takeaway that would appear with the use of this invention when the reader's cursor passed over a specific area of text could appear off on the side of the parent page and not above the text being read, as is the case with IntelliTXT ads.

The TakeAwaz technology, on the other hand, acts in an opposite manner. Instead of bringing up additional material, it brings up “less”, so to speak. That is, the new information displayed is a summary of certain material already on the page. No new information is necessarily displayed. As opposed to a hyperlink, which leads one to more information, the TakeAwaz “link” leads to less information, that is a condensed version of information already at hand. In this sense, it is the opposite of a hyperlink.

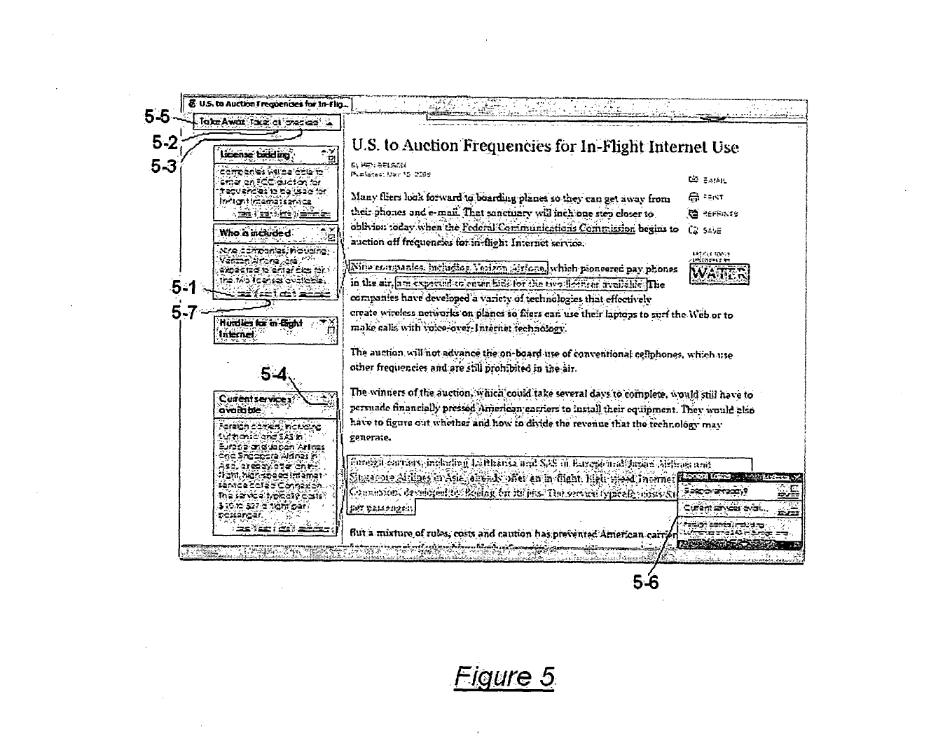

Another form of takeaway, the “built-in takeaway,” might be comprised of summaries that consist of text taken from the original page as shown in FIG. 5. (Such a takeaway might be similar to one that a reader might be forming when highlighting text with a yellow marker.) Viewing options for such a takeaway would be similar to those described above—they could be automatically displayed or not, and the associated geographies of the notes could be toggled on or off.

On the other hand, the takeaway could comprise just the highlighted, bolded, or otherwise visually modified text and have no ancillary text in the margin. A takeaway could comprise one or more segments of such highlighted text even if such segments were separated by un-highlighted text or otherwise separated. Highlighting on the parent page associated with “built-in” takeaways could be persistent or could disappear after takeaways were saved (via a process described below). Furthermore, such highlighting could reappear if the page were revisited in the future by that user.

If the parent page could be highlighted in advance of reading such that key points are apparent, users could then click on a given highlighted area, or on a command such as “save”, or an icon denoting such command, and then such text would be automatically copied to an input form from which a takeaway could be generated and saved by the user. This technique is similar to that used by other web snippet extraction programs except that here the author assists the process by creating logical highlights ahead of time in addition to offering within the website the software needed to extract the highlight with a simple click, thus eliminating the need for each user to download such software to their computer or browser, or have a special version of a browser.

The reader would be able to save the displayed takeaways in several ways. By clicking on an icon or text link within a takeaway 5-1 of FIG. 5, the user could indicate a desire to save a particular takeaway. Clicking on a link, such as “take all” 5-2, would save all such takeaways on that page.

Alternatively, TakeAwaz could display a checkbox within each takeaway. Users would merely check the box for each takeaway that they wished to save in a manner similar to how users check off boxes to indicate specific emails to be deleted. Once the desired boxes are checked off, the user could then click on a “Take checked” option 5-3. A visual clue would indicate takeaways that had already been saved, for example their check boxes 5-4 could be shaded and rendered inactive.

Each blog or website employing the invention could offer an on-line “storage locker” for individual users to store their takeaways. Users could initially set up and enter such a locker by merely requesting to save their first takeaway. If the blog or site had already registered the reader, placed a cookie, or had some other means of identifying the user, this information would be used to match the reader to their locker. Otherwise, the reader would need to register in order to set up and use such a locker.

A user might have lockers for one or more blogs or websites. These separate lockers could be aggregated at the “back end” into a single locker to which the user could navigate. At that aggregated location, all the user's takeaways from all sources could be accessible and managed.

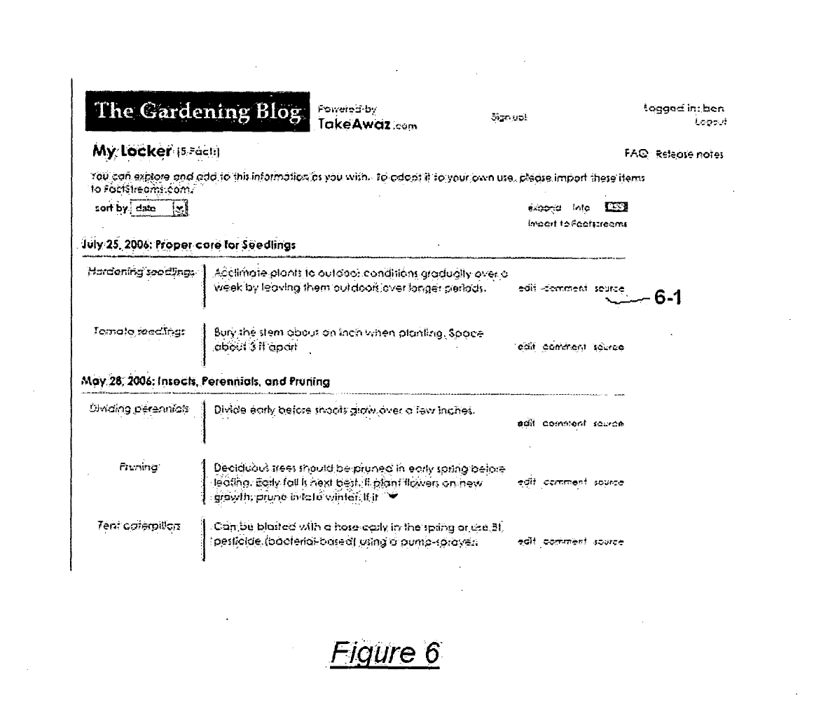

In some instances, a reader might be interested in seeing already-generated takeaways from older postings or other web pages from the website or blog currently being viewed without necessarily seeing the associated parent pages from which the takeaways were derived. This might be the case, for instance, if a new reader to a blog were trying to catch up on older postings that had not been read. In this instance, reviewing takeaways as a substitute for reading the full version of previous posts might be a satisfactory way to catch up. A means would therefore be presented to allow users to navigate from the parent page currently being read to an area where they could view and navigate only takeaways derived from other pages or postings. This could be done by clicking on a link such as TakeAwaz link 5-5. Once perusing such a presentation of takeaways, as in FIG. 6, a means would also be available to navigate back to the original page or posting of a given takeaway. An example of this means is link 6-1.

Some readers might wish to automatically save future takeaways from a particular site or blog. As such, a “Save Future Takeaways” option would be offered. Such a feature would also allow takeaways from that blog or set of pages in a particular website to be automatically saved to the user's TakeAwaz's storage area. Such pre-determined saving of takeaways could be a function of tags assigned to takeaways by the author or other readers. Alternatively, the reader could enter keywords or search terms into an input form and if such terms appeared in subsequent takeaways they would be automatically saved.

A reader could also click on a link on the parent page which would then show all “recent takeaways”, takeaways that had recently been saved by the user. These recently saved takeaways could be presented as a list 5-6 on the page being read and could represent takeaways saved by the user from the website or blog currently being viewed or from other sources as well. Alternatively, the reader could be taken to their storage area upon clicking such a link.

Such recent takeaways could also be presented within a widget that did not need to be called up by the user and which would always be present for viewing. Such a widget could also recycle older takeaways in ways other than just presenting a list of the most recently saved. For instance, only highly rated takeaways could be shown. (See “RSScycle” below.)

Each takeaway would contain metadata including the URL for the parent page from which it was derived. If a user was viewing a takeaway in the locker area, the user could navigate back to such parent page by clicking on a link employing such metadata. When the parent page was loaded, the user could control whether the takeaway is of interest, or all takeaways associated with that parent page would be juxtaposed with the display of the parent page's text of interest.

Users would also be able to edit already-generated takeaways. This could be done by clicking on the edit links in takeaway boxes 5-7. This link would take the user to a form where the existing takeaway could be edited. Such edits could be saved if the user saved that particular version or alternatively, saving could be done automatically as part of the editing process.

Another feature would allow a user to create an entirely new takeaway. To do this, a user could click on a “new” command, which could be part of the edit menu. This command would present a blank form, which the user could fill in. To create a geographical linkage to the related text on the parent page, the user could drag the takeaway over to the margin beside the related text, drag a geographical location symbol to an appropriate spot, or in some other way establish the geographical relationship.

Each such user-generated or edited takeaway could be automatically saved in the user-controlled storage area, or a save command could be presented at the time of editing.

A further capability associated with the editing process would be the ability to tag a takeaway. Such user-generated tags would be saved with the saved takeaway. These user-generated tags could be in addition to any tags created by the author. The user would be able to search and organize their locker of saved takeaways by tags.

In addition to the value inherent in storing takeaways and being able to access and use them as separate objects, it is the further intention of this invention to offer value by improving the experience users have when returning to the original parent page. As such, it would be desirable that when users return to the original parent page they can make use of the information filtering that they had done in previous visits to this page.

Thus, TakeAwaz would offer websites an ability to detect a visit by a user that had already saved takeaways in the past. When the URL was reloaded, only the saved takeaways would be presented along with the original parent page. Any edits to such takeaways would also be shown. The desired level of detail, if different from the default settings, would be shown as well.

Alternatively, the parent page could display saved as well as non-saved takeaways, with the latter being distinguished from the former in some visual manner, perhaps by only showing their names (and not the descriptive note) or by making these takeaways transparent.

Means would be offered, however, for the user to restore all the takeaways that were not presented because they had not been saved.

Takeaways may be created by either the author or readers. When an author creates the takeaways, they are “published” meaning that they are visible to all readers. When a reader creates a takeaway, it is visible just to that reader. Groups of readers may be formed in which case takeaways created by one member of the group are visible to all other members. Authors may be able to see all takeaways created, or the ones that are designated as public, and “promote” one or more to published status, such that all readers see such takeaways.

If the parent page was already created, the input form for the takeaway creation tool would be juxtaposed beside the text from the parent page. Alternatively, other text, such as an outline from which the post or page would be created could be simultaneously viewed.

A tool by which authors could easily create takeaways could be tightly coupled to tools that help authors create blogging posts or web pages. Tight integration with such authoring software would also allow for the most ideal presentation of the takeaways to reader when viewing the published page.

When the author has the parent page to work from, it would be advantageous in certain cases to re-use text from that page instead of typing each takeaway in from scratch. Thus, when the author highlighted text on the parent page it would automatically appear in the input form. Separate words, sentences, or paragraphs could be highlighted, one after the other, and the resulting segments would be copied to the input form. No dragging of text or cutting or pasting would be necessary for these copies to be made. In addition, the author could still type in text, as well as copy it off the parent page. An “undo” button would be available in the input box in order to roll-back additions that might have been done in err.

Tags and other organizing metadata could be entered by the author or reader during the takeaway creation session or editing sessions that might follow.

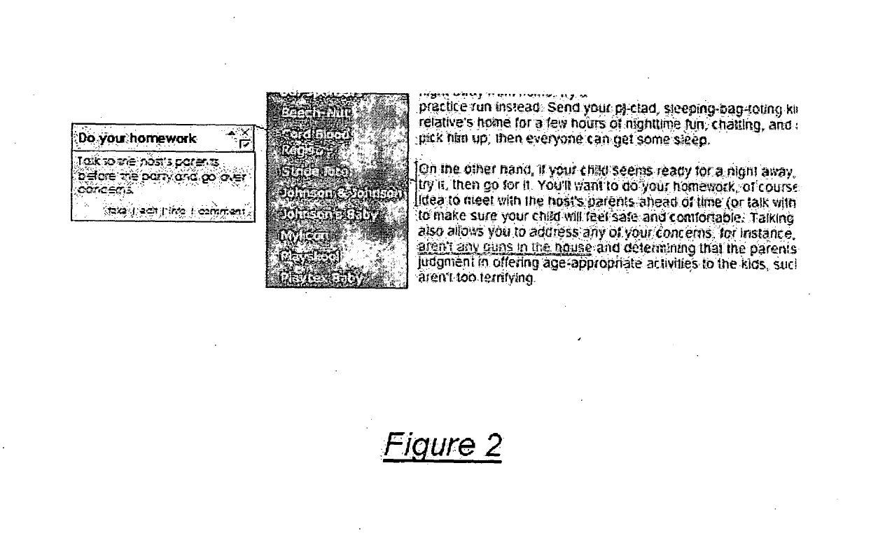

Means would also be available to specify the geographical linkage between each takeaway and the post or page. Ideally, this would be done with the parent page and the related takeaways displayed on the screen at one time. A type of “geographical pointer” would then need to be selected, such as the triangle approach shown in FIG. 1 or the bracket approach shown in FIG. 2. The linkage could be specified by dragging the tip of the triangle to the appropriate location or dragging lines to brackets that had been placed beside various locations.

The author of the parent page could also be involved in pre-arranging the storage locker in a particular manner (i.e., by, automatically sorted by page, date, author, subject matter or by other attribute). Means could also be available for the reader to organize the takeaways, over-riding the author's scheme or in place if one were offered.

Users would also be able to create takeaways, by employing a downloadable “browser tool”, browser extension, or built-in browser feature that would allow readers of any web page to create takeaways for that web page. Such a tool would be more limited than in being able to link each takeaway with a specific geography on the page, particularly for dynamic pages that change over time. This issue could be addressed by expressing takeaways as floating bubbles not necessarily linked to exact locations on a page.

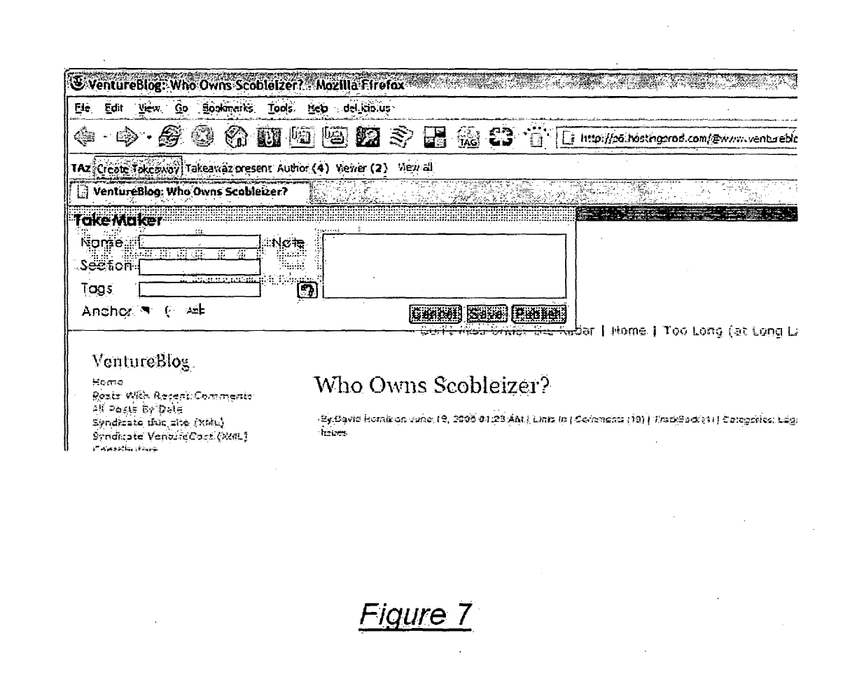

To start the creation process, the user would click on the “Create Takeaway” link on the browser bar. This would bring up an input form similar to the one shown in FIG. 7. Such an input would be similar to that available to authors. It would allow for the creation, tagging, and the geographical linking of a takeaway to an area on the parent page. Each such user-generated takeaway would be automatically saved in the user-controlled storage area. Users would have the option to make any and all takeaways “public”, or accessible to other users. These features are all used in other note taking products.

The TakeAwaz input technology would be distinguished from other similar products by three features. First, is that the input form could be set to automatically appear whenever the user started to highlight text on a page or started to type on their keyboard while the PC had a webpage in focus that had no input form ready to accept input. Such highlighted or typed-in material would automatically load into the Note section of the form. Furthermore, each time material was highlighted this material would be added to the Note field automatically. These shortcuts would save the user from having to click on the input form every time a takeaway was to be created and having to drag multiple sections of highlighted material to the input box.

With this automatic input capability, it is possible that a user could accidentally input more text than desired. In this case, an undo button could be provided, which would remove the last section of text added to the field. Clicking this button multiple times would remove successive highlights from the field.

Also unique is an elastic note input box, which expands as text is entered. In an effort to avoid covering a large section of the parent page when the input form is opened, the Note box will initially have a limited size. As text is entered into the note box, it will expand in size to permit viewing of the entire note.

The third distinction is that the destination within a user's locker where the takeaways would be saved would default to the last location used. Alternatively, it could be a location associated with the parent page or the website to which the parent page belonged.

Ideally, the browser would be able to re-render the parent page such that the takeaways could be displayed beside the text of interest on the parent page after each takeaways was created. Part of this re-rendering process might entail deleting from view material peripheral to the main text of the parent page. Such material might include widgets on a blog, advertisements, sidebars, etc.

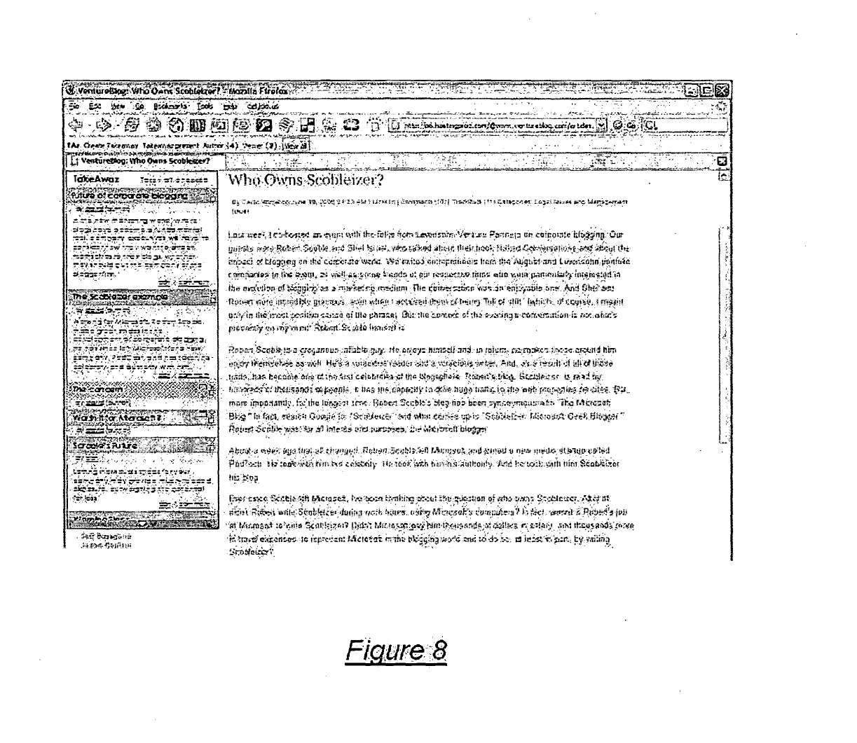

If re-rendering the page was not desired or possible, then a pop-up window or other sort of overlay technique could be used to display the needed information when required, such as in FIG. 8.

Another means to juxtapose takeaways with the parent page would be to present the takeaways in a transparent overlay which would allow them to be clearly read while still allowing the user to see the original text.

The server storing user-generated takeaways would also contain a database of all the web pages that had been “annotated” in this manner and made public, along with the associated takeaways and the authors along with their profiles. When a user of the takeaway browser tool navigated to such an annotated page, the browser button would indicate that the user was now on an annotated page. Clicking on a command in the browser tool would display the takeaways in a manner as described above. The user could then edit and save such takeaways as if they were generated by the user or the author.

An alternative model would allow the user to control the presentation of takeaways in such a way that the takeaways were automatically presented when the annotated URL was loaded.

If more than one user had generated takeaways, this fact would be presented to the current reader. The current reader could select which set of users' takeaways to present on the page based on metadata presented about the choices available. That is, different sets of takeaways could be ranked by popularity, word usage (suggesting the sophistication of the annotator), date, desired level of detail, or the identity of the creator. The current reader could have a relationship with the creator (i.e., being in the same work-group), have a profile that matched in some way that of the creator, or have shown interest in similar takeaways. Such information could be used as a means of selecting the most appropriate set of takeaways.

The browser extension could be set to automatically present the best-fit set of takeaways whenever a reader navigated to an annotated page.

Before and after the selection of the desired set of takeaways, the current reader would always have accessible an easy way to toggle through additional sets of takeaways so that the best match could be obtained. Such a series of takeaways would be sorted by the system so that the best sets of takeaways would be present first.

The system could also present takeaways by mixing and matching them from different authors. That is, the one that was deemed to be the best for the introduction might be from a different author than the one that the systems presented as the best fit for the conclusion. Users could edit and save takeaways from multiple annotators.

Conversely the user could instigate the mixing and matching by searching through different sets of takeaways from different authors at any time. That is, if a user was interested in seeing other perspectives on the concluding arguments, a list of takeaways linked to this geography could be presented and the present reader could navigate through them to find the desired one to save or edit or merely read.

Another model of takeaway use that the invention could support would be to allow creators of takeaways to share them among a specific group. Such a model would require a user to instigate the formation of a group, preferably by “inviting” others to join via an email to which they would reply. Other methods of making “friends” in a social networking context are well known, and such friends could serve as the basis for a group.

Once sharing or friend-relationships are established, the server could then distinguish between takeaways that were available at a visited URL from the general public versus those available from users that were included in these special groups. Visual indicators could illustrate when takeaways from either class of users were present and available.

The system would provide data that allowed users to ascertain which creators of takeaways were the most popular or most frequently used. In addition, users would be able to objectively rate such creators giving them specific grades. Such grades could be specific to certain aspects of their work, such as brevity. Creators could also have profiles so that users could learn more about them and their interests. Finally, the system could provide statistics about their work, including the number of URLs annotated, the number of users saving their takeaways, etc.

When a user navigated back to a page, which had previously been viewed by that user, the browser extension could be set to automatically display only those takeaways that the user had saved. In this manner, the user could easily go back and read a parent page with just the takeaways of interest displayed. These takeaways would be displayed with the level of detail as last set by that user for any given takeaway. Setting such levels of detail would be similar as that described for author-generated takeaways above.

Alternatively, the parent page could display other takeaways in addition to the ones saved with these others being distinguished in some visual manner, perhaps by only showing their names (and not the descriptive note) or by making these takeaways transparent.

There are many social bookmarking sites on the Internet, which offer users the opportunity to share lists of their favorite web pages. A goal of this invention would be to make such URL sharing more useful by adding takeaway information to such social networks.

Thus, if a user shared bookmarks with one or more “friends”, takeaways from these friends would be preferentially or exclusively shown when multiple sets of takeaways are associated with a parent page. Furthermore, the takeaway database associated with this invention would be accessible to the social bookmarking site allowing any bookmarks that had associated takeaways to be annotated as such. By noting which URLs had associated public takeaways, users of the social bookmarking sites might preferentially access these URLs over others with no takeaways.

Social bookmarking sites when displaying lists of bookmarked URLs could indicate not only which had takeaways associated with them but other data as well. Such additional metadata could include information concerning how many users contributed takeaways, what the users' ratings were, how often other readers had saved such annotations, etc.

The database component of this invention, Factstreams, is an online database and collaboration tool which would allow users to collect, save, organize, and share facts. A fact in this database would have a structure similar to a takeaway as described above, with fields for a name, a note, classification tags, an associated URL, and others, as well as associated metadata such as date and author.

In Factstreams, facts would be organized into related lists called “streams”.

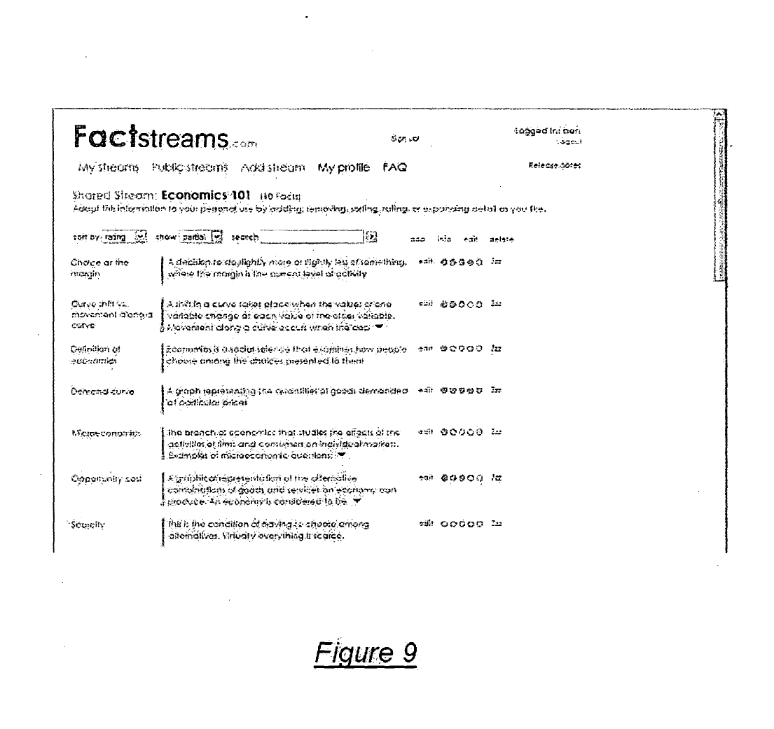

An example of the view within a stream is shown in FIG. 9. The stream's simple, tabular format allows the entire stream to be seen with minimal navigation.

Each stream would have an audience type associated with it. Streams viewable by anyone using Factstreams would be considered public. If viewing rights were restricted to a single user, the stream would be considered private. If the stream could be viewed by a limited number of users it would be deemed a shared stream. Users would have their own private copies of public streams after importing them, and their own private copies of shared streams once they “joined” a shared group. All these user copies as well as private streams, could be seen by the user in their MyStreams “vault”.

Users could build their own streams by collecting facts, and could also “import” a copy of any other accessible stream and “subscribe” to updates to that stream. Unique to Factstreams would be the ability to add additional private facts to such an imported public or shared stream. Thus, a user could import a public stream, subscribe to any new facts generated for that stream, and furthermore, add new facts that would be private to that user. Streams therefore can be made of any combination of imported or subscribed facts and user-generated facts.

While other on-line applications allow a user to import data such as OPMLs and lists of bookmarks and add personal additions to it, Factstreams is unique in allowing a user to subscribe to such sets of data and control the future addition of new information.

That is, a stream can be established and made public by any user allowing any other user to see it. Any user can then make a copy of such public stream for their personal use. This user would then have the option to subscribe to all future additions and edits (or updates) to the public stream. That is, if a new fact was added to the public stream, this new fact would also be added to their private copy of the public stream.

Alternatively, the user could have made a one-time copy in which case there would be no automatic future updates. An option would exist in that case, however, to “Check for Updates”. Invoking this option would have the system search the associated public version and copy all missing facts to the user's private copy.

As another means to import facts from a public stream, a check box could be associated with each individual fact. By checking off items and clicking a link to “import all checked,” the user could pick and choose the facts to be imported into their private collection. In addition, a “check all” link could be provided as another means to import the entire stream. For facts that have already been imported, checkboxes could be rendered inactive, preventing repeat imports.

Additions to the private streams via subscriptions could require that the user review and approve such additions before such new facts are added to their private streams.

It should be noted that a stream could subscribe to a stream. Thus, a public streams could also subscribe to other public streams. The same mechanism described above would apply to such subscribing streams with the exception that the “owner” of the public stream would make decisions regarding checking for updates and approving additions. In the same way, shared or private streams could subscribe to any other stream or streams that the associated user had access to. A shared stream, then, could subscribe to a public stream. Once a user had then added private facts to their copy of such a stream, that stream would then contain a mix of private, shared, and public facts.

Streams could also be “daisy-chained” such that one stream feeds another that then feeds another via the subscription methodology. Factstreams, however, would prohibit circular chains from forming which would result in continuous importation of a fact.

Facts may be edited by any authorized person. Such edits would cascade down to all streams that were subscribed to the parent copy. An option would be available, however, to alert (via an email alert, for instance) the downstream user that a fact was about to be edited giving that person the opportunity to accept or reject the change. Another option would be available for the person updating the fact to override the alert system so that other subscribers would not be “bothered” by alerts for minor changes.

Authorized users would be able to copy one stream into another, in essence merging streams. Streams that were copied could then be deleted in order to reduce the number of streams while still preserving all the facts.

Facts may link to the stream from which they flowed or were copied. Such a link could be shown via a link when an expanded view of the fact is presented. If a parent stream is deleted or removed from “view” or made inaccessible for any reason, only these fact links are severed along with the continuing subscription function. Since a fact in a given stream is a copy of another fact, these copies are not destroyed or changed by changing any status of the originating source.

Setting up a shared stream could use well-known techniques whereby a user would specify the members of the sharing group either by e-mail invitation or by providing user names. The Factstreams system would send each invited user a confirmation notice (e.g. an alert viewable within their user profile, an e-mail, text message or other communication method). When confirmed, the user would be granted access to the selected shared streams. Each confirmed group member could then have the privilege to invite other members to the group.

A unique feature of Factstreams sharing would be a “pushed” stream subscriptions model for a group. For example, a creator of a stream could choose a keyword, words, or phrase, which when present in stream titles or stream descriptions, which would cause the stream to automatically send out an invitation to a pre-set group to share the stream. A more automatic setup would bypass the invitation step and automatically import such stream into the personal streams storage area of each group member thus resulting in the same outcome as if all participants had accepted an invitation to share the stream. A final mode of automatic sharing would be for a stream creator to have the ability to sign up other users for sharing without their direct participation. In all cases of such non-invitation based sharing it would be advantageous to alert the user in some manner that they were now sharing a new stream with certain other users.

Another form of an automatic subscription would allow a user to specify keywords that may occur in a stream name or description. If such keyword or words occurred in a public stream, then that stream would be automatically imported.

There are multiple models for sharing and allocating or permitting activities among users of a shared database such as Factstreams. In the most open format, the “wiki” format, any user can perform the four basic functions of Add, Delete, Edit, and Copy/Export. At the other end of the “control spectrum” is the “read only” model where only the owner or creator could control these functions. These various levels of control apply both to shared streams (which can be thought of being public but where the “public” consists of a limited number of people) and to public streams.

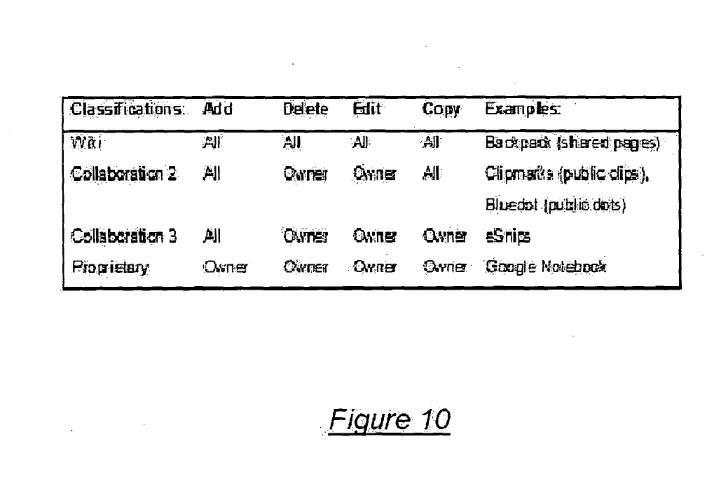

Other various levels of control are illustrated in FIG. 10. Typically, any given website offers at least one such level of collaboration.

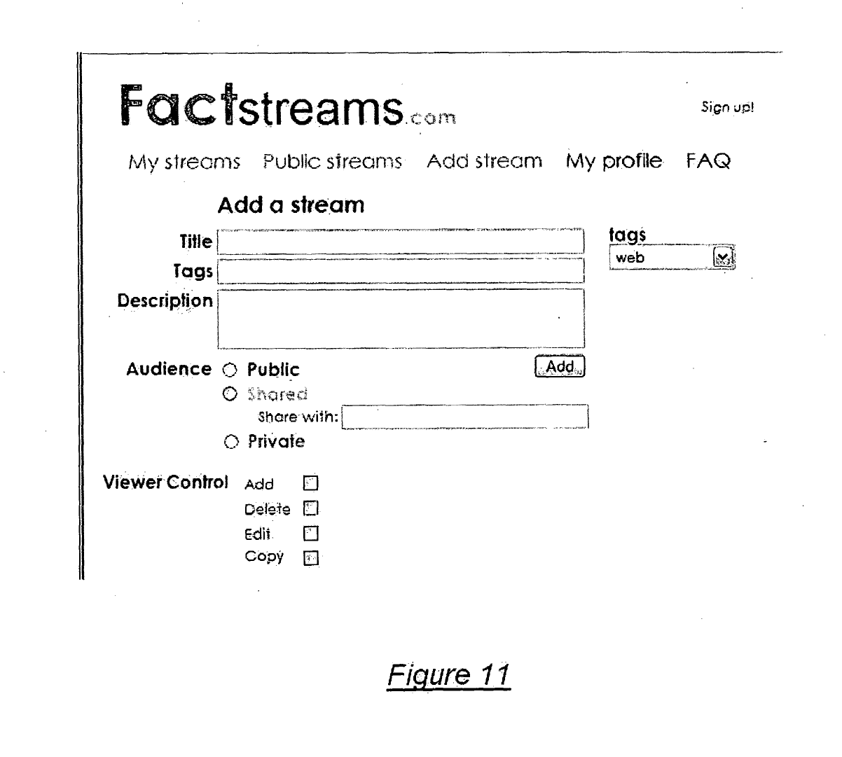

Other possible combinations of permissions to perform group or public stream functions could also be created, however, resulting in other levels of collaboration. Factstreams would allow the creator of a stream to interact with a GUI that looked like the one in FIG. 11 in order to create a custom level of collaboration. This system could allow the stream creator to customize the level of user or reader input on the stream by determining whom within a shared group (or the public if the stream was a public stream) could Add, Delete, update existing facts, or take away copies of facts. Such settings could be set as the stream was being created or at a later time.

Many websites offer the ability of users to rate items of interest and some will average or blend such ratings to produce an average rating. Factstreams also allows for such a group or public rating function for both individual facts and streams, which would average such individual ratings. In addition, however, Factstreams would offer some unique features.

The first unique feature is that the averages could be produced by assigning different weights to each user rating a fact or stream. Such weightings could be assigned by the owner of the stream or assigned in some other manner. Automatic weightings could also be derived from various statistics. For instance, a user whose previous ratings came closer to the average rating would be considered more “mainstream” and be given a higher rating. In other situations, a user who had contributed more in terms of adding additional facts to a streams or editing facts could be “rewarded” with a higher weighting: A user who had a greater interest or apparent expertise in an area, determined by the activity level involving this or related facts or streams, the number of related streams and facts that the user owned or had created, or the degree to which the user “knew” such facts, would give that user a greater weighting.

The second unique feature is that users could be given a finite number of “voting rights” based on any of the weighting schemes mentioned above or the number of voting rights could be equal among all users. Users would then be able to “spend” such votes on any fact or stream they wished. Thus, if they had a very strong belief about a certain rating, they could allocate more of their voting rights to such vote. To prevent a small number of users from “tipping the scales” too much in such a scenario, the system could cap the number of voting rights one user could allocate to a rating or such voting rights could be given diminishing value the more that were used in one vote.

The third unique aspect is that multiple ratings could be employed for any given fact or stream. Thus, users might rate a fact for its overall level of importance and how well they thought they knew or had learned the fact. Other ratings could be applied to any dimension of the fact of stream, including ease of understanding or the “evergreen-ness” of the information.

Ratings in one dimension could affect ratings in another. For instance, if a user rated his understanding of a fact as very high, and also rated the fact as very important, his or her rating of quality might count for more.

Different graphic skins could be available. Thus users could have the ability to rate importance on a one to ten numerical scale while quality could be rated with a five-star system.

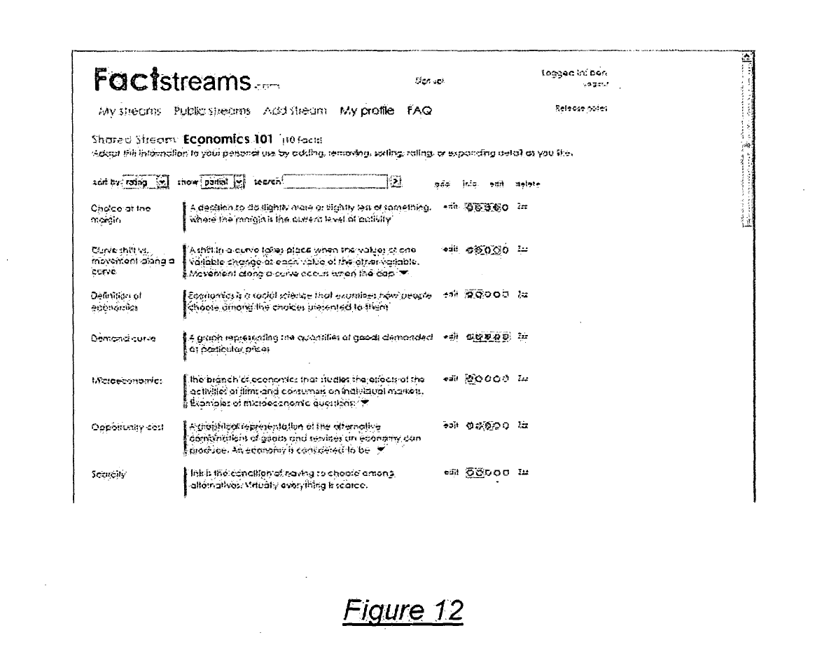

The fourth unique aspect of the Factstreams rating system would entail the concept of consensus. Thus, instead of merely averaging together all users' responses to get an average (even after dropping off “outliers”), the system might also indicate the level of consensus achieved. This could be done visually by showing a range within which a certain percentage of responses fell. An example of a consensus representation is shown in FIG. 12 where the range of responses is highlighted:

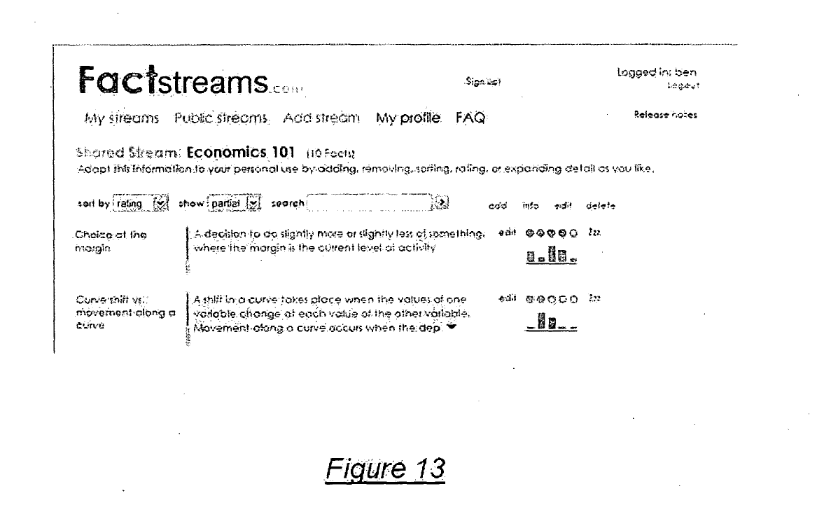

A more informative representation of the consensus concept is shown in FIG. 13, where a histogram shows the relative quantity of responses that each rating drew.

These various rating techniques could be applied to any application involving user generated content which is rated by users.

Users could be reminded of which audience could view each fact within a stream by a color-coding or other visual scheme. Thus, when users viewed one of their own streams, they would be able to see, preferably via a colored icon, that a given fact was set to be viewed only by the user, only by group members, or could be viewed by anybody. Such color coding would allow users to easily keep track of the privacy levels of each fact. Ideally, green would indicate that a fact was set to be private and only viewed by the user. Yellow could indicate group viewing and red would indicate that a fact was a publicly viewable fact because there was a copy of such fact in a public stream.

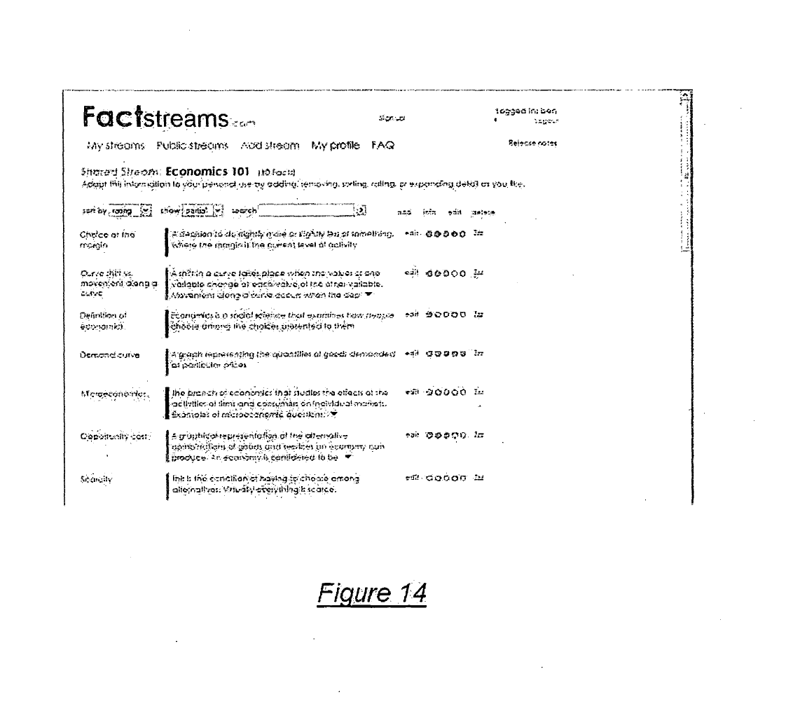

The icon that displayed such color coding, the “metadata bar”, could be a bar between the fact name and the fact note. A color-coded example of this bar is shown in FIG. 14 where red-yellow-green are shown as different shades of gray. The bar could be used be to express other attributes as well. For instance, the bar could include a fact's status as new or unread, where “read” meant that the user had at least opened up the webpage with the new fact at least once.

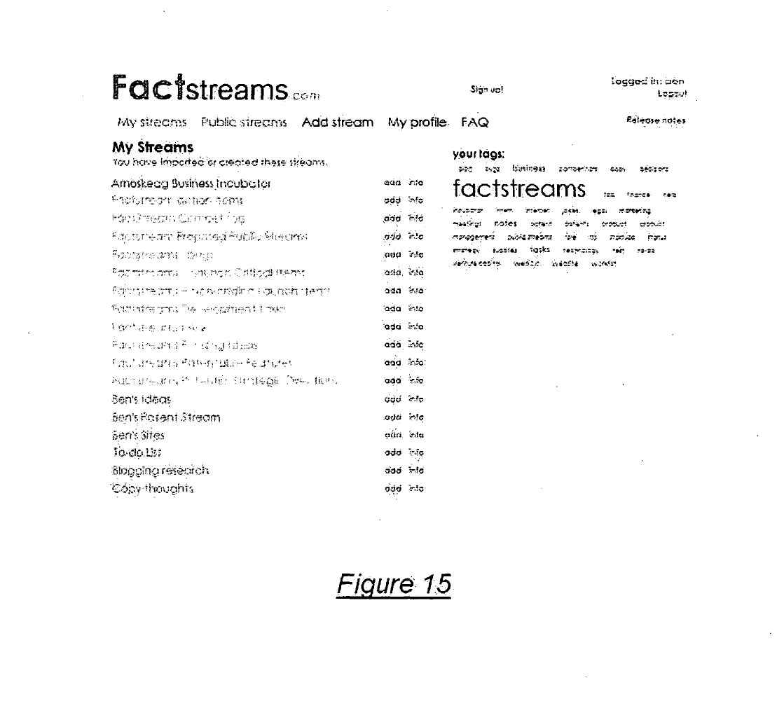

At the stream level, that is on the My Streams page where a list of a user's streams are presented, the color coding could continue with stream names and/or audience headings (if the list was sorted by audience) being colored as shown in FIG. 15.

In the cases of both lists of facts within a stream and the list of streams on the My Streams page, the lists could be sorted by audience (i.e., color).

Specific streams to which a user had subscribed could be configured to make the user aware that new facts had been entered into that particular stream via an alerts system. Alerts could take the form of a mobile device message, e-mail messages or other means of asynchronous communication. In addition to alerts, a user could learn about the existence of newly imported facts by looking at the stream at the Factstreams site and noting the visual designation given to new, un-viewed facts. Alternatively, the user could go to a “special stream”, “Recent Facts” where both newly imported facts and newly created facts would be shown, regardless of which stream they were assigned to. Another means of alerting users to the existence of new facts within their subscribed streams is via RSS technology. Thus streams, or sets of streams, could be configured to produce an RSS feed consisting of new facts, and optionally edits, to such streams. The title for each RSS item could be the fact name, and the item description could be the fact note. Other methods of expressing facts as RSS elements are discussed below.

Often a user will update a fact or add a new one but not want to “bother” subscribers of the stream with an alert for what might be a minor change or addition. In this case, the user would be able to optionally block the sending of an alert for that particular update or addition.

While other sites allow users to receive e-mail alerts when their subscribed lists of postings are updated or added to, Factstreams is unique in its ability to include the entire Fact in the alert message. In addition, the alert messages could be a basis by which to edit the fact's content (name, note, rating, etc.). This would free up users from having to navigate to the Factstreams site when wishing to edit newly imported facts. One such method could allow the user to forward an e-mailed alert to a dedicated Factstreams e-mail address after making changes to the fact as originally sent in the alert email. The Factstreams system would then recognize the e-mail address of the sender and change this user's private copy of the note to reflect the changes made in their forwarded e-mail.

Each alert could also contain a link or other interactive construct to allow the user receiving the alert to block the fact's automatic inclusion in that user's stream. Thus the alert could be used as an interactive tool to decide whether to accept or not accept a new fact or edit. Either acceptance or rejection could be set as the default in case the user did nothing with the alert.

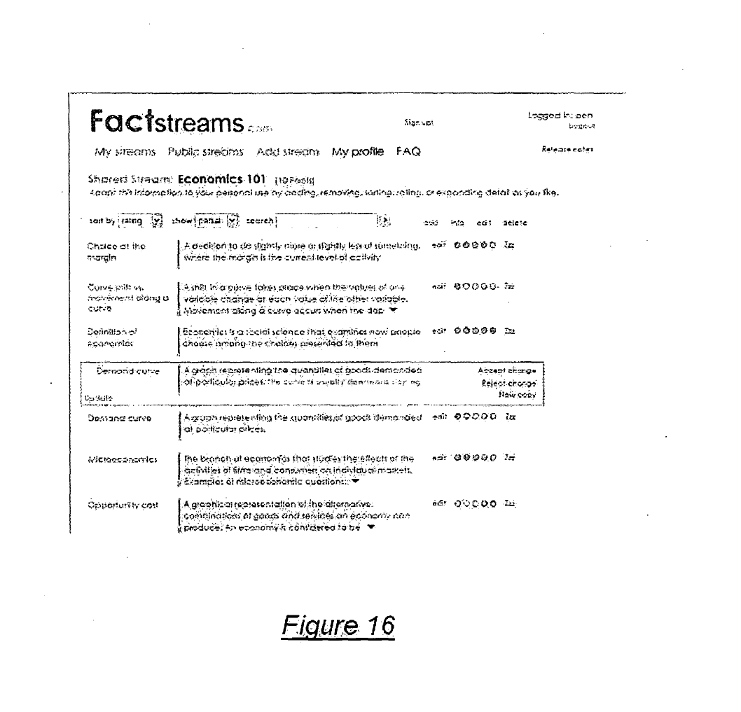

For alerts about updates or edits to facts to which they retained copies, users could be provided a link to an interface through which they could compare their saved copy with the new public or shared version, as shown in FIG. 16. To compare facts, each could be placed in close proximity to the other. Alterations could be highlighted by differences in text or background color or by the font or style of the text itself. From this page, users could have the option to adjust their private fact copy by editing its elements, or could import a fresh copy of the updated fact.

Many RSS feeds available on the web are not just lists of article titles but rather comprise a series of content-objects such as word-of-the-day, jokes, or other fact-like elements. Factstreams would be able to convert such feeds into streams for use in the Factstreams database.

To convert an RSS feed into a stream of facts, code would be placed in Factstreams to have it serve as an RSS reader allowing each RSS element to become a new fact. RSS titles would be automatically placed in the fact name field, while the description, if any, would be placed in the fact note field. Date, URL and other fields in Factstreams could also be filled out automatically from similar metadata contained in the RSS feed.

To organize or sort facts within a stream, users could implement single or multiple sorts on various fact fields (e.g. name, date, section, rating, and author). Once preliminary levels of sorting have taken place, for instance by sorting by Section first and then in rating order, the user would then have the option to specifically move facts “manually” to new positions not necessarily dictated by the previous sorts. Such movements would use the feature dubbed “MySort” and could be done via an interface that would allow users to number the facts, manipulate up and down arrows, or preferably by using an AJAX-based drag and drop methodology. Such manual manipulations could be done a single fact at a time or in groups if the user had designated sets of facts beforehand.

The order resulting from MySort would be a result of the combination of any preliminary sorts done on fact fields beforehand combined with the manual manipulation that followed. The resulting sort order would then be memorized by Factstreams as the MySort order for that stream. The user could put the stream back in that exact order by merely sorting on the MySort option. New facts added since the last manual manipulation would be inserted in the order they would be in had they been in the stream before the manual manipulations had been performed but after the sorts on various fields. Optionally, if the new facts would have been included in a designated block of facts that was manually moved, they would be treated as if they were moved with the block.

As an additional feature, if preliminary sorts were done by section or tag, and the user manually moved facts between classifications, the user could be prompted with an option to change the fact's section or tag. For example, if a fact were originally classified as “Section 1”, and was then moved under heading “Section 2”, the system would prompt the user and ask if the section name should be changed for the fact. (When the stream was then sorted by “section”, this new assignment would then apply.) This could be implemented for sections, tags, ratings, or any other classification means.

Many sites offer users the ability to tag content by associating words or phrases with specific items. Such tags are often presented in “clouds”, or clusters on a webpage with the more commonly used tags in larger letters. In some cases it is more convenient, however, to reuse an already used tag rather than add to the existing list. Tag clouds and drop-down menus containing all the existing tags can be provided to assist with this re-use.

It is also preferred to use fewer tags in general so that each tag in the cloud represents all the items tagged by users with the same thought in mind. If a certain tag were spelled several different ways, for instance, this proliferation of tags could affect the importance ranking of that particular tag.

To address these issues, this invention offers an organizational feature, dubbed “Tag Drag”, that could provide users an AJAX-like ability to drag tag names from a tag cloud or other tag repository to the tag input field in the fact creation or editing form. Using the control key, multiple items could be highlighted at once and such group of tags could then be dragged to the tag input box. Any tags dragged into the tag input box would automatically be associated with the tag with the fact to which it was dragged. Tags could also be dragged out of the tag input box to break such association. Once dragged out of the box the copy of the tag would disappear.

An even quicker method to populate the tag box would be to locate the cursor in the box and then highlight individual tags. Each highlighted tag would appear in the box without a need to drag it over to the box.

To associate new tags with pre-existing facts, it would also be possible to drag facts from a tag cloud over the general area of an entire fact, and not just into an input box, thus associating this tag with the fact. This would eliminate the need to open the edit dialog to gain access to the tag input text box.

Such dragging of tags from tag clouds to individual content pieces need not apply only to the Factstreams context; it could be implemented wherever such tag clouds were present.

Users may also have the ability to add to a stream by sending a message from a mobile device to Factstreams via text messaging. In one such implementation, a user could create a fact with the fact name entered into the text message's subject line, while the fact note could be the body of the message. This message would be sent through a mobile provider's SMS gateway by calling the Factstreams cell number. The user's Factstreams account could be recognized through the mobile number from which the message was sent. To implement this means of identification, the user's mobile number could be included as part of their Factstreams account information. Facts would then be directed into a stream of the user's choosing.

One solution for finding the correct stream within which to place the fact sent via SMS would be to provide the user a stream dedicated to receiving mobile facts. All facts sent via mobile devices could be directed to this stream to be sorted and edited by the user at a later time from the Factstreams site.

The user could also set up their Factstreams account to redirect incoming mobile facts by specific keywords when possible. For example, if the user had a stream with an associated mobile keyword “to-do” and this phrase was also contained within the text message, the fact would be automatically placed in the “To-do” stream.

Another solution to placing the facts into the correct stream would entail the user coding the stream name, and possibly section, as the first element in the text message or subject line. Such metadata could be delimited by special characters in order to allow for its extraction.

Factstreams offers organizational features whereby facts can be organized by “source” in unique ways. Unlike other bookmarking sites that do not allow information to be entered by hand (such information having no corresponding URL), Factstreams allows information to be added that does not have an associated URL. Users are able, however, to assign a designation as to where the information came from. For example, a user could designate “John Smith” or “water cooler” as the source of a fact. Factstreams allows for the easy re-use of such sources via a drop down menu offering all previously used sources either for that specific stream or for all streams under the control of the user.

In addition to tracking manually-input sources, Factstreams will parse website identities from specific URLs associated with facts. Thus, Factstreams will analyze URLs such as http://www.amazon.com/dp/B000P6YNSE/ref=s9_asin_title/103-7633956 and http://www.amazon.com/dp/0312347294/ref=s9_asin_title 1/103-7633956 and determine they both are from the www.amazon.com website. Thus, Amazon, described at http://www.amazon.com (the information posted on this site is incorporated herein by reference in its entirety), will be deemed to be the source of both facts.

Using both manually-input source information and derived website source information, Factstreams helps users find where they are getting the “biggest bang for their reading buck”. That is done with the My Sources feature, which presents a frequency listing of sources. That is, it presents a list of each manual or website source along with the number of facts originating from that source each over a period of time, sorted with the most frequently cited source at the top,

In addition to offering this frequency listing, Factstreams also offers such a frequency list weighted by the rating of each fact. This list therefore grants more importance to sources that produce facts with the greatest importance.

Users could also use the My Sources feature and the frequency analysis to produce an OPML file that could be used, for instance, as input when setting up an RSS reader.

Users could also link from the My Sources of Factstreams to a “synthetic” stream where all the facts from any given source would be shown. Such a stream could be sorted and manipulated like any other stream.

Once users have saved and organized facts of interest in the aforementioned Factstreams database or other bookmarking or notes database, it could become advantageous to have an easy way to re-view some facts or portions of the fact (for instance, the name only) without having to go back to the originating website. It would also be advantageous to repeatedly re-view such information. Such re-exposure would allow the user to memorize the information if desired, become more familiar with it, or simply to place previously acquired information in the place where it can be most quickly referenced, and be reminded that the information is in storage.

“RSScycle” is a feature of the invention that uses the existing RSS infrastructure or a widget to accomplish such a re-viewing function with regards to facts. It would allow users to configure their own RSS feed or widget output comprised of “items” (which could be bookmarks from a site like de.licio.us as described at http://del.icio.us/(the information posted on this site is incorporated herein by reference in its entirety), facts from Factstreams, or notes from Google Notes but for purposes of this discussion will be called “facts”) of their choosing and view this feed (which for purposes of this discussion, is a stream of facts) through their RSS reader or widget.

The RSScycle re-presentation of facts is designed to allow the user to “digest” or utilize the facts as they are presented as feed elements shown by the RSS reader. Thus the representation of the feed itself (consisting of any of the basic elements of a fact-a URL, title, description or note, rating, tags, etc.) would have a high utility as a content form even if the user did not click through and see the actual URL. That is, just seeing the fact itself, be it a bookmark, fact from Factstreams, or a Google note, has a high utility even if the user did not click through to the associated URL. This is in contrast to the usual use of RSS where the presentation of elements is largely a list of headings and intros that are written expressly to lure the user to read a full-length article at another site.

Therefore, the RSScycle feed items viewed on the RSS presentation page would be designed to provide significant value, in and of themselves, and would not merely be an initial point of navigation to get to a URL. This value would come from any special formatting they received, as well as from the fact they are shown in a particular pattern as described below. It should be noted, however, that RSScycle feed items would still contain links to the Factstream site and/or the primary URL that the fact was linked to and would therefore still have a secondary role as points of navigation.

In short, RSScycle uses the RSS system not just as a navigational tool, but also as a presentation tool for short pieces of information, and in the process takes advantage of the frequency with which users visit RSS presentation pages.

The invention would therefore allow a user to:
1. Generate an RSS feed comprised of a set of items or facts where elements of the fact are mapped onto specific RSS elements. For instance, the title of each fact becomes title of the article normally found in an RSS feed. The note or description in the fact would become article description normally found in an RSS feed.
2. Manage the publication dates of individual facts in the feeds, as well as creating copies of a fact and appending them to the feed in such a manner that it causes certain facts to reappear in the RSS reader repeatedly at certain intervals and/or at certain times as determined by the user. Such control over various means of repetition would facilitate familiarization, learning, and memorization. The system, therefore, not the user, manages the publication dates. The invention allows the user to generate an RSS feed in which certain elements of that feed will reappear in the RSS reader at periodic intervals.
3. Optimize the configuration of each fact as it is translated into an RSS element such that it makes best use of the format and polling characteristics of the RSS reader being used by the user.
4. Interact with each fact, for instance, by clicking on a link to go directly to the originating URL
5. Use the rating of the fact to change it recurrence frequency and change such rating when desired.

A RSScycle feed could comprise any set of information elements that would be useful if re-presented while the user was doing “other work” on the Internet, specifically while using an RSS reader. Such repeated exposure would enhance the learning and retention of information of importance to the user.

RSScycle could work independently of Factstream. That is, information elements or items in the RSScycle feed could come from many sources, for instance the elements could come from other RSS feeds, data from a spreadsheet, or information from other sources. In particular, facts in the feed could come from any “personal database” (such database being the user's information stored on a website such as de.licio.us, Factstreams, or Google Notes, or a retail site such as Amazon, or a social networking site such as Facebook, as described at http://www.facebook.com/ (the information posted on this site is incorporated herein by reference in its entirety). Items that could be recycled by RSScycle could also be obtained by using the APIs of other applications in a mashup fashion.

A RSScycle feed could be generated from the Factstreams database by specifying that an existing factstream would generate a RSScycle feed. Alternatively, a feed could be comprised of individually selected facts, or multiple streams, or a combination of individual facts and streams. Users would subscribe to each RSScycle feed using any RSS reader in the usual fashion.

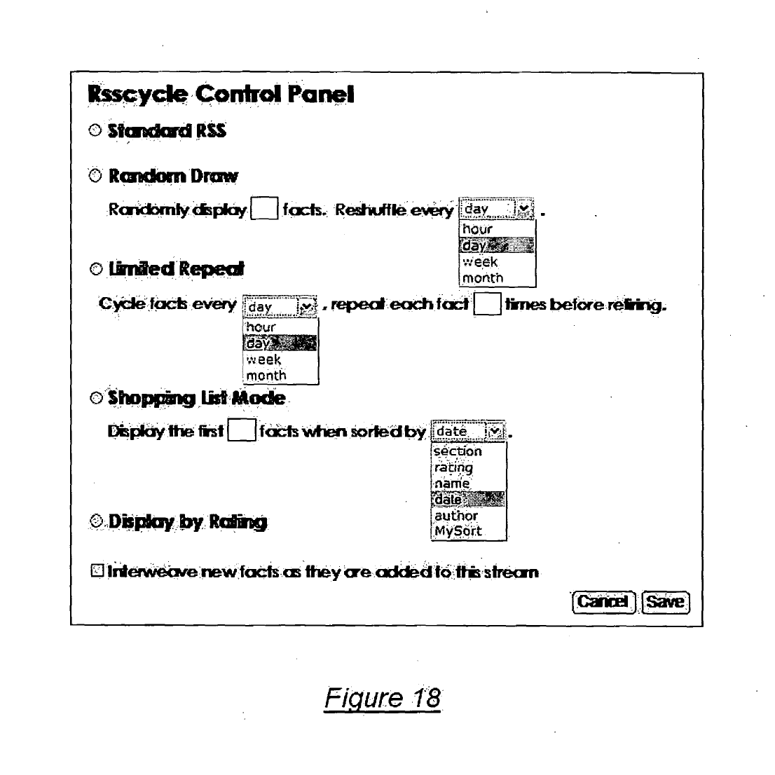

Users would be given various options when programming the recycling characteristics of a feed. A control panel showing such options for programming a feed generated from a fact stream could look like FIG. 18.

In this example, users are given five options in controlling fact exposure and repetition. In the first option, the fact feed behaves like a regular RSS feed. That is, the most recently added facts appear at top of the list on the RSS presentation page. In this case, the facts are sent to the RSS reader in the same order as they appear in the fact stream. Fact publication dates correspond to the dates the facts were entered into the database.

The second option, Random Draw Mode, allows information to be selected at random from the sources that comprise the feed. Elements may therefore appear repeatedly, but not according to a specific schedule. Such a pattern of repeated exposure to saved information might be useful for somebody studying such facts or for a user trying to remain familiar with a set of facts over a period of time.

The third display option shown in FIG. 18, Limited Repeat Mode, would allow the user to specify that each fact that is selected from the stream to be included in the feed be shown X times, or repeated for a specified period of time.

Each exposure would be spaced apart by an hour, day, week, month or some other time interval. The time for which each exposure is ‘live’, i.e. being transmitted as part of the feed—would also be specified. The time of day information is added to the synthesized feed can also be specified to ensure that users are exposed during the hours they habitually read their RSS feeds.

Information for the feed could be selected from the stream in a number of ways, such as clicking on individual facts, highlighting sections of the stream to be included, or selecting the whole stream. Similar means could be employed to select data from other sources.

The fourth display option shown, the Shopping List Mode, in FIG. 18 continuously presents all items from the source via the feed, but allows the user to choose the order of the list. If the list is sorted in order of importance, for instance, this method would keep the most important items “front and center” for the user by constantly displaying them on the user's RSS reader.

The final option shown, Display by Rating, allows the presentation of facts that have a certain rating, where the rating scale could indicate fact importance, the extent to which the user knows the fact, or any other attribute about the fact. In effect, the user specifies how soon she wishes to see each particular fact again, or may inactivate particular facts from reappearing in the feed, on an individual fact basis.

In cases where the rating scale represents a user's knowledge of the fact, the Factstreams server could record statistics on how well the user recalls each factual association, and it would use the learning statistics to schedule future re-presentation of the facts via RSScycle, to facilitate optimal memorization.

In the case of all these patterns of repetition, there may be more facts than the user wants to recycle that fit the criteria or the RSS reader may limit the number of items it can show from one feed. In these cases, a method would be offered to limit the presented facts to a subset of the stream. In the case of the Limited Repeat or Display by Rating modes, a “lens” could slide down the list of facts and present facts that qualify in the order that they enter the lens.

Numerous other recycling patterns and sources of items could be offered, as well. For instance, a feed could be configured using elements from a calendar program. To visually schedule information appearing in the RSScycle feed, the user could highlight specific items laid out in calendar form to be displayed on the RSS presentation page. Furthermore, the user could use the calendar interface itself to specify the dates that it was desirable to see each item presented. Thus, the user could select an important anniversary coming up on Saturday and then highlight all the days of the week (and even hours of the day) preceding that date for which it would be desirable to have the event appear on the RSS reader's presentation page. Furthermore, each day could have a different exposure pattern—that is, the event could appear on the page all day or just after certain polling activities by the RSS reader. The title of the item could be programmed to change too.

Other recycling schedule patterns could be tied to the appearance of new information, instead of only being driven by elapsed time. In one such variation, the content of new facts could be semantically analyzed and related facts could then be incorporated into the RSS feed as a result of that analysis such that related facts are shown together on the RSS presentation page. The ratio of blending could be controlled so that users either see mostly new information with a trickle of old facts, or they see mostly repeated information.

A simpler blending of new and old information is represented by the check box option in FIG. 18. By checking this option, the user will see the selected RSScycle behavior, however if new facts are added to the stream, these will be displayed until they are no longer classified as ‘new’. This way, the user could re-view their facts as desired, while still being kept up to date on new additions to their stream.

Data specifying the recycling pattern could be imported from another source, for instance, if the elements to be recycled came from a spreadsheet. In this example, the facts could comprise one column on a spreadsheet. Another column could specify the desired presentation pattern for each item. RSScycle could have an import mechanism to take in such data along with the presentation metadata and create the appropriate feed that when interpreted by the RSScycle function produced the desired result on the RSS presentation page.

To accomplish such programmable presentation of facts and others pieces of information, the invention could use a technique whereby the publication date of any given item was varied in order to achieve the desired result. Thus, RSScycle would create, in effect, a parallel feed or list, viewed by the RSS reader only. In the case of a Factstreams, a parallel RSS feed would be synthesized for each stream that the user wanted to view through RSScycle. It would contain the subset of the items in the stream that the user wanted to recycle and any new items added to the feed since the stream was last visited. Facts selected to be recycled would be appended to the RSS feed as XML elements with new publication dates. The master publication date of the RSS feed would then be updated to indicate the appearance of new elements on the feed, triggering the RSS reader to update its local feed copy.

In some cases, it might be necessary for the user to specify information regarding what RSS reader is being used to poll the stream as readers can have different polling behaviors. By knowing information such as how often the reader polls and whether the reader keeps copies of previously read elements, the software described in this invention would be able to manage the publication dates and copies of facts as RSS elements in a manner that optimally formats the RSScycle feed. For example, if we know that a particular RSS reader does not maintain local copies of RSS elements, the RSScycle manager would retain all previous copies of an element in each future generation of the RSS feed.

Another way that RSS readers differ is in their display of XML metadata. While some readers are preconfigured to display only article titles, others display titles, descriptions, and other items such as publication date and copyright information. A limited number grant users control over these display characteristics. It is the intent of RSScycle to provide users the ability to manipulate this metadata at the fact level in order to optimize fact display by their particular RSS reader, in particular those that only present title information.

If the reader only displays RSS element titles, then all information related to a fact being placed on the RSS feed would be limited to a maximum of one hundred and sixty characters. This is a restriction based on the RSS protocol specification. For a feed consisting of brief informational items, this limited length might not be a problem.

When the item is naturally longer than this one hundred and sixty character limit, as it might be in the case of a fact from a fact stream, it may be desirable to format the RSS element with a “compound title”. That is, a new title for the fact would be created just for use with RSScycle and this title would be designed to optimize the limited amount of space available within the one hundred and sixty character limit.

This compound title could comprise the fact name, a delimiter, and additional text that could provide a short summary of the fact note, the total number of characters not to exceed 160 characters. Such a title could be exposed only to the RSS reader while the original fact data format would continue to be used for viewing within the fact database. The compound title could be generated by the RSScycle function automatically by simply combining the fact name and a delimiter, and then adding enough text from the fact note field to fill out the one hundred and sixty characters of the title.

Another option for a title to be used with RSScycle could be a manually constructed title. Thus, the user could have been given the option ahead of time, perhaps at the time the fact was input, to compose or create manually a custom title that would be only used when recycling the item. Note that this compound title might use less than the allowed one hundred and sixty characters and may or may not use a structure consisting of a name, delimiter, and subset of the fact note. Users might also specify that certain metadata such as repetition count be automatically included in the title or description field of the output elements.

A third option would be for the user to construct just one fact note but do so recognizing at the time that RSScycle software will later construct a custom title from the fact name and the beginning of the fact note. Knowing this ahead of time, the user when composing the fact note could make an effort to ensure that the first one hundred and sixty characters (consisting of the fact name and beginning of the note) comprised a usable summary when displayed by the RSS reader.

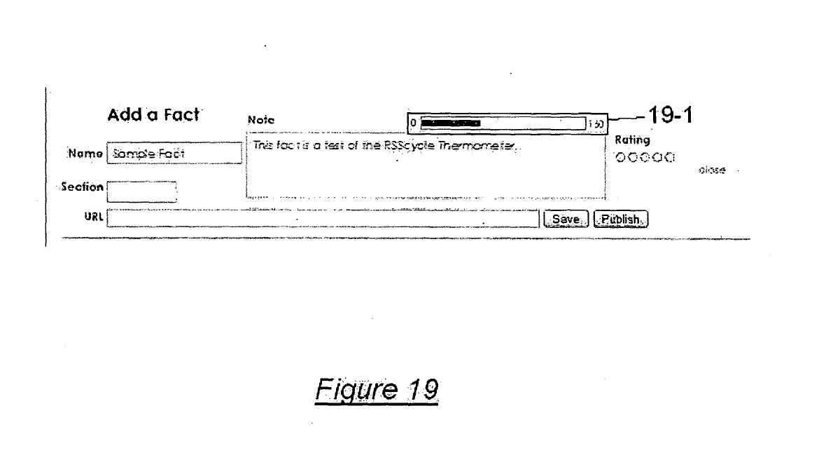

An input form for creating such a fact note is shown in FIG. 19. In this example, the user is advised, as the note is being created, how many characters are represented by the fact name plus the note text up to the current cursor location. The total number of characters is represented as a “thermometer” 19-1 that goes to one hundred and sixty characters. As the user types in text, the thermometer fills to a maximum of one hundred and sixty. Other visual means to communicate how much note would fit within the one hundred and sixty character limit could include a shaded box into which such typed text would fit. Or a counter could be put beside the input form. The user could determine that less than one hundred and sixty characters need to be used by merely inputting a delimiter into the text at the desired break point.

When viewing the full fact note via the Factstreams application or other means, the portion of the note that is presented by the RSS reader could be visually indicated to the user by inserting the delimiter, shading the background for that text, or via some other visual means.

Note that in cases where the user's RSS reader displayed the full description, a custom title would not be needed and the RSScycle feature could be programmed to present various levels of note detail, such levels of detail having been described above.

While there are circumstances where the user would want to maximize the information conveyed by the fact title when seen through the RSS reader, at other times, less information might be appropriate. Such a circumstance might occur if a student was using the RSScycle feature to study certain facts to memorize associations, as with flash cards. In this case, “Flash Card Mode”, it might be desirable to hide the note portion, and thus display only the fact name, perhaps allowing the user to see the associated note portion on demand.

In another study mode, the user could program RSScycle to only show a note summary. In this “Jeopardy” mode, the user would be presented with the “answer” (the fact note summary) and strive to think of the “question” (the fact name).

Both Flash Card and Jeopardy Viewing Modes would be available to users when viewing facts at the Factstreams website.

Users may wish to have facts and other information items presented to them at times when they are not viewing an RSS page but rather when they are merely browsing the web. “Factbar” could be such a tool. This utility could be a downloaded extension to an existing browser, such as Firefox, or could be built into a browser such as Internet Explorer. With Factbar, more control could be obtained over the presentation of facts and how users could interact with them.

Factbar could be an omnipresent utility, always active while the user is browsing the web. The Factbar display could occupy several lines of text at the top of page or take space at any other suitable location. Such use of space could be easily turned on or off with a click of a “close” icon. The basic function of Factbar would be to read RSScycle feeds and present facts that needed to be re-exposed. There would be direct communication between Factbar and the code within RSScycle that serves the RSS feed described above so that the latter could merely push facts to the former to be displayed. RSScycle, however, would have no need to manipulate publication dates and wait for an RSS reader to poll the site.

With Factbar (instead of an RSS reader) to re-present facts, users could have more control over the presentation format. For instance, a user could program Factbar to scroll facts across the top of the browser with such scrolling speed being set by an on-screen control. Or facts could present themselves for a specific amount of time and then be replaced. Instead of individual facts being displayed, groups of facts could be represented by a “tab”. Clicking on such tab would drop down a number of facts to be viewed in a mini-window.

With Factbar, the one hundred and sixty character limitation is not necessarily an issue and users could expose their facts in various levels of detail. Such settings could be controlled in a Factbar control panel.

Factbar would also offer the advantage of allowing users to interact with specific facts. That is, a user could click on a fact to change its presentation to show more detail. Users could also click on a fact to change its rating without going back to the feed source. Such ability would have great utility to students studying facts as they could rate the extent to which they understood or had learned each fact and thus, via the rating, control the reappearance of such facts.

Users might also be allowed to edit the RSScycle elements in-place on the Factbar display, in order to create more evocative display titles as information becomes active and is viewed in context. This differs from normal RSS reader functionality, which allows read-only viewing of feed elements.

Factbar could also allocate some of its screen display space to present advertising. Such ads could be chosen to reflect the content of facts being shown in the Factbar at that time or the content being read on the webpage of interest to the user.

Factbar could also interact with Factstreams such that a new fact just created in the Factstream form could be dragged to the Factbar for repeat presentations. During this action, the user would establish the parameters of such presentations.

An alternative to Factbar would be to use a widget that recycled facts in the same manner. While not as omnipresent as Factbar, it would offer the same control and presentation flexibility of Factbar as it would not be constrained by the limits of the RSS system. Such a widget could be installed on a user's homepage such as the ones offered by iGoogle, as described at http://www.google.com/ig?hl=en (the information posted on this site is incorporated herein by reference in its entirety) or Netvibes, as described at http://www.netvibes.com (the information posted on this site is incorporated herein by reference in its entirety).

FactFinder is a utility—installed as a browser plug-in, built-in as part of the browser, or built into select websites—that will scan a webpage being read and do an analysis of the content. Such an analysis may be a semantic one such as that offered by Sphere, or a literal one where certain words or phrases are noted. It will use the results to try to find matching material from content directly controlled by a reader—that is, their “personal data”. Such personal data may reside in a database like Factstreams, de.licio.us, as described at http://del.icio.us/ (the information posted on this site is incorporated herein by reference in its entirety), or Google Notebook, as described at, http://www.google.com/notebook (the information posted on this site is incorporated herein by reference in its entirety), or in any number of other sites featuring user-generated content. Personal data may also reside in retailing sites like Amazon, described at http://amazon.com/ (the information posted on this site is incorporated herein by reference in its entirety), where personal shopping histories, wishlists, and gift registries are stored, or social networking sites like Facebook, described at http://www.facebook.com/ (the information posted on this site is incorporated herein by reference in its entirety), where profile of a reader's social circle may be stored. Other personal data may come from a group-generated database that is accessible by the user.

Mashups, increasingly popular on the web, allow the data in one application to be combined with another to form a new application. In effect, FactFinder is an “auto-mashup”. That is, it combines data “owned”, generated, or accessible by the user, and combines that with data gleaned from material being read by the user, preferably blog posts, articles, or pages of a website.

This approach differs markedly from the other examples of systems that provide users with more information, that were mentioned above in the Background section. FactFinder is trying to find a match with information that, in general, the user has in some form or fashion touched, read, or been involved with. The match becomes a link to the past. The other examples are attempting to bring new information to the user.

FactFinder is looking for a match with information that has personal value or interest to a user. Such interest may have been expressed by the user either bookmarking the URL containing the information, constructing a note about such information via Google Notebook or Factstreams, or adding someone to a social network such as Facebook. FactFinder takes a user's reading material and uses it as raw material to look for more information that relates to information users have already saved, bookmarked, created, or expressed an interest in. The other approaches assume an interest in what you were reading and looked for complementary material. Thus this FactFinder approach asks the question of “Within what I'm reading, does the application or program see any matches within my established and personalized body of interesting information?” versus the other examples that ask “I'm interested in what I'm reading, can the application or program find further similar items to read?” The other methods spread out the user's attention; the FactFinder method focuses that attention.

In other words, FactFinder is a means to let users know when they have “bumped into” content that had been of interest in another context. It highlights serendipity. The other techniques do not consider the fact that specific information may have been of interest in another context or not or that the user had “captured” some form of that information in their personal database of information.

FactFinder differs from the aforementioned alert systems as well, as FactFinder does not require the explicit input of terms and phrases that the system should be on the “lookout” for. In that sense, FactFinder is largely automated once installed and will constantly match content against personalized data—such personalized data having been created by the user to primarily to fill another function, such as saving bookmarks or building a social network. Alternatively, the information in the personalized database may have been generated by a third party but relate to the user, for instance that tag cloud of product interests created by Amazon that can be seen in a user's account.

FactFinder can operate at the page, post, or article level of detail or it can deal with select text that the user designates. If when dealing at the first level FactFinder finds a match, the browser could highlight the matched text on the page being viewed, either using conventional highlighting with a background color or using a unique underscore or a normal underline. (If the match was a general one, however, there might be no specific text to highlight. The matched process could still be undertaken.) Such matching process might be automatic or instigated at the command of the reader when desired.

Once a specific match is found, any specific matched material on the site being read could be highlighted. Once highlighted or underscored in this manner, the user could click on the material. This action could take the reader to the URL, which would display the matched personal information—that is, the matching fact in Factstream, bookmark in de.licio.us, or personal profile in Facebook. This option for matching material is similar to how a post can be “Sphered.”

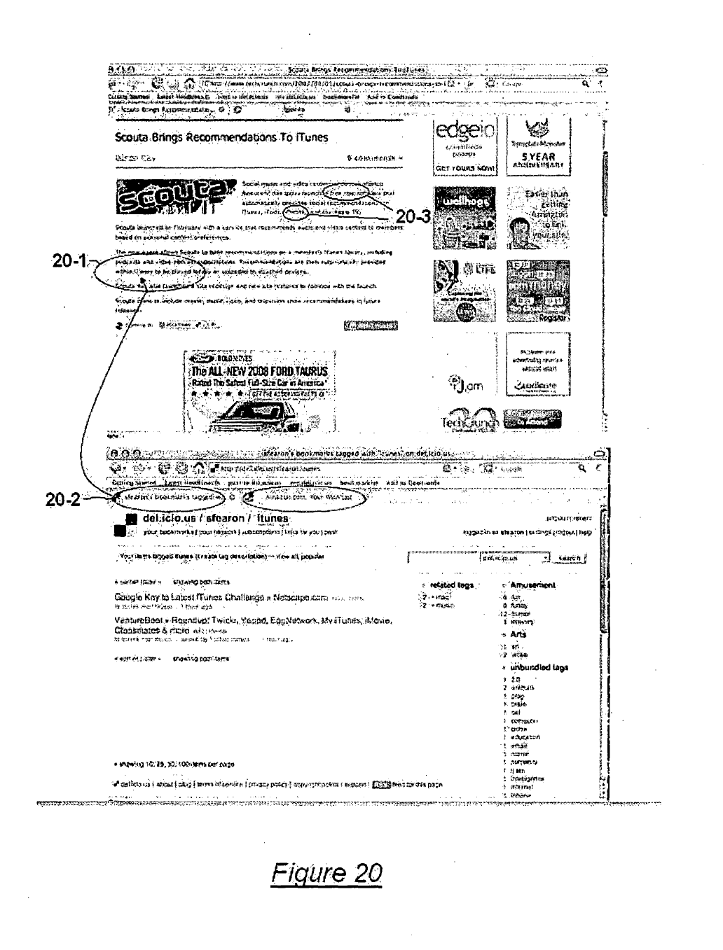

If a user opens a page that contains data that has related “facts” available in the user's personal database, those terms/paragraph 20-1 and 20-3 will be highlighted to indicate a “fact” match has occurred, as shown in FIG. 20. If the user selects a term to “factfind” by clicking on the highlighted area (in this case “iTunes” 20-1), new browser windows open that contains the URLs within the personal database where facts about this term are found. In the instance illustrated in FIG. 20, the word “iTunes” has saved “facts” on the user's Del.icio.us and Amazon.com pages 20-2, therefore these site pages will open up on the specific site that contains these facts (in the case of del.icio.us, the user's page of any posts tagged “itunes” is opened). Alternatively, information could be extracted from the other sites and placed in a hover over the page being read. This information could be useful in and of itself, or could be used to let the user navigate to the other pages at the remote sites.

Alternatively, the user could select specific text from the material being read and use that material for the matching process. A command, perhaps accessed via a right click, would instigate the matching search once the text had been selected. FactFinder would then go search the user's personal data to see if an appropriate match was available.

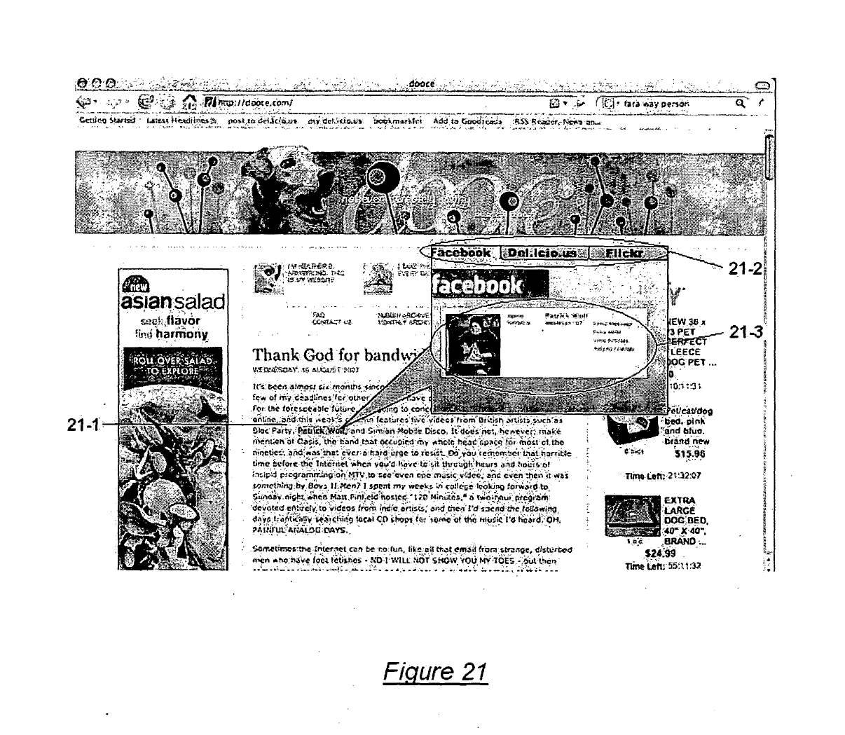

In FIG. 21 the user has highlighted the name “Patrick Wolf” 21-1, after clicking on the highlighted text the Factfinder scours that user's databases to try to find any information in his/her list of database site that reference that name. A hover pops up on the page with tabs for each of the user's specified sites that contain information about the highlighted term 21-2. In this case Facebook, Del.icio.us, and Flickr all produced “facts” regarding “Patrick Wolf.” The tab that is open displays the information from that site (in this case the Facebook tab is open) that Factfinder has found regarding the highlighted term. In the diagram, Facebook produced the profile of “Patrick Wolf” in the hover box 21-3. The user also has the option to change between these tabs to see the information that is important to them.

Matched personal information could be displayed in a number of ways besides being viewed at the originating site via a link. The information, for example, could be extracted from the remote site and displayed either in a widget on the page being read (assuming that such page had allowed for the placement of such widget that could view information retrieved in such a manner). Another way to display the matching material would be show a hover that would be overlaid on top of the page being read. Such a solution would not require the cooperation of the site being read but could be implemented by the browser function or via a browser plug-in. Alternately, a new browser tab or window could open up showing just the extracted material, or a sidebar in the browser could show the information.

The user could control which of the above methods of displaying the matching personal information could be used. In addition, the user could control what types or form of personal information was displayed. For instance, if the matching information came from de.licio.us, perhaps just the URL title would be shown. Or if the matching information was a person's name, just the picture from that person's profile in the reader's social network would be displayed. The user could also specify the minimum strength of the connection desired so that tenuous matches would not be shown and the user could optionally ignore differences such as plural/singular or capital/small letters. The match strength could also be determined and conveyed to the user. That is, if a person's name was close but did not exactly match one in a Facebook network, perhaps the picture would still be displayed.

If the matching information was displayed in a hover, such a hover could offer interactivity. For instance, if the hover contained a fact from Factstreams, such a fact could be given a new rating if the rating scale was included in the hover. In the same manner, a user could interact with matching information in a widget or browser bar, as well. Thus, there could be a two-way flow of information between the construct containing the extracted matching material (i.e., the hover, widget, browser bar, etc.) and the database, located perhaps on another server, from which the matching material was obtained.

In order to find the matching material, FactFinder would need to be configured to be able to access the user's personal databases. Thus, in setting up FactFinder, the user would specify which of his or her personal databases were to be used to in matching data, what the relevant user names and passwords were (so the FactFinder search tool could peruse each database looking for matches) and how the information was to be presented (Flickr photos first, then facts from FactStreams, etc.). Ideally, other websites would agree ahead of time to participate by exchanging user data with FactFinder so the user would not have to specify each application's username and password. Alternatively, one of the emerging ID standards, such as Open ID, could be harnessed in the same way to reduce the task of authorizing the retrieval of personal information.

FactFinder would be especially useful for students studying vocabulary words, for instance. When a word on the vocabulary list being studied appeared in a webpage being read, it would be highlighted thus giving the opportunity to see the studied word being used in a “real-world” example. By looking at the fact note and being able to rate it, the learning process can be incrementally advanced.

FactFinder's ability to scan the page for matches and partial matches, and to perform semantic analysis, could be used to control the flow of facts through via RSScycle in a more useful or pertinent manner, as well, as the context would be ideal for reviewing information bookmarked or saved in the past. Thus, if the text being read appeared to relate to health issues, then such a circumstance could prompt RSScycle to display multiple facts taken from a stream with a similar focus. Alternatively, if electronic products were being reviewed on the page being read, RSScycle might present facts from a stream on electronic products. Ideally, these would be displayed in a widget on the page being read or in a hover.

FactFinder could also work with extensions to other applications, such as Word or Outlook, such that material presented by these applications could also be scanned in the same way for matches with stored facts. Such extensions would ideally highlight matched words or phrases and present the matching fact on the page when possible. Alternatively, the match could be presented on a browser page when a match was found, perhaps juxtaposed with some or all of the text from the Word or other application, which had been cut and pasted into the webpage. As word processing and mail applications increasingly move to the web, FactFinder will be able to perform such matching without need of a desktop plug-in.

In the case of Factstreams, presentations of matched material would allow the user to interact with such material by being able to change the rating, click back to the page presenting the fact, edit the fact, or perform other functions that could normally be done when the fact appears in the Factstreams database.

In addition to a user's desire to be reminded of when a fact re-occurs in what they are reading, users might also wish to highlight facts when they recur in material they are writing.

Glossarizer would be an extension, or part of another extension, or a feature in a browser, and could also be provided as a tool for authors of informational publications such as blogs. It could also be linked to extensions in Word, Outlook, and other programs, and would be present on the Factstreams website as well. The function of Glossarizer would be to create hyperlinks for words or phrases that matched users' facts in as automatic a way as possible.

Thus, a user may be composing an email using an on-line mail program, or a blogging tool, with the term “permalink” in the message. This term might be the name of a fact in that user's fact stream of technical terms. If the Glossarize button in the browser extension was clicked, the system would scan the contents of this email, and then find the word permalink both in the email and in the name-field of the Factstreams database. Based on this match, Glossarizer would construct a hyperlink in the email or blog page for this word that linked it to the Presentation Page for this fact.

This function could be automated such that the Glossarizer button need not be clicked to activate the match-making process—it could be always on, looking for matches and creating links continuously as the user composed email, composed a blog posting, wrote using Word, or entered text in other ways or for other programs.

Glossarizer could also function on the Factstream website. It would have an input box into which users could cut and paste text that was to be used in a user-written document. Such text could be scanned and links to matched facts embedded in the text. The text could then be pasted into other applications.

From the foregoing, it will be clear that the present invention has been shown and described with reference to certain preferred embodiments that merely exemplify the broader invention revealed herein. Certainly, those skilled in the art can conceive of alternative embodiments. For instance, those with the major features of the invention in mind could craft embodiments that incorporate one or more major features while not incorporating all aspects of the foregoing exemplary embodiments.

With this in mind, the claims that follow will define the scope of protection to be afforded the invention, and those claims shall be deemed to include equivalent constructions insofar as they do not depart from the spirit and scope of the present invention. Certain of these claims express certain elements as a means for performing a specific function, at times without the recital of structure or material. As the law demands, any such claims shall be construed to cover not only the corresponding structure and material expressly described in the specification but also equivalents thereof.

1. (canceled)

2. A method for transferring selected information from a web page into a personal database maintained on behalf of a user, said method comprising, in combination:
operating a web server coupled via the Internet to a web browser operated by said user,
creating a web page containing displayable information content and one or more selectable controls, each of said one or more selectable controls being visually associated with a portion of said displayable information content,
transmitting said web page to said web browser to display said displayable information content and said one or more selectable controls to said user,
receiving from said web browser a designation of at least a specified one of said selectable controls selected by said user, and
in response to the receipt of said designation, transferring reference data specified by said designation to said database, said reference data including the URL of said web page and data identifying said designation or specified by said designation.
